(19) United States
(12) Patent Application Publication
(10) Pub. No.: US 2015/0050630 A1
(43) Pub. Date: Feb. 19, 2015

(54) TRAINING SYSTEM FOR EDUCATING USERS ABOUT A HEALTH CARE SYSTEM

(71) Applicant: Robert F. Hanlon, Chaska, MN (US)

(72) Inventor: Robert F. Hanlon, Chaska, MN (US)

(21) Appl. No.: 13/968,960

(22) Filed: Aug. 16, 2013

(51) Int. Cl. G09B 5/02; G09B 7/00; G09B 23/28

(52) U.S. Cl. CPC G09B 5/02; G09B 23/28; G09B 7/00
USPC 434/262

(57) ABSTRACT

A method of educating a user on a health care system includes providing access to a plurality of educational topics through the web site. The educational topics relate to user interaction with and navigation through a health care system. The educational topics are arranged in a pre-determined sequential order including: pre-event information including information on one or more educational topics that educate the user on how to interact with the health care system before a health care event occurs, active event information including information on one or more educational topics that educate the user on how to interact with the health care system during the occurrence of a health care event, and post-event information including information on one or more educational topics that educate the user on how to interact with the health care system after one or more health care events has occurred.

### BACKGROUND

The health care system in the United States is complex and is difficult for some individuals to understand and use efficiently and effectively. Considering all the choices an individual may need to make, from finding a doctor, to dealing with insurance companies, to understanding treatment options when sick, the individual may sometimes be overwhelmed and not know how to proceed. Considering the need to understand nutrition and good health practices to attempt to prevent health issues, individuals may feel even more overwhelmed. In addition, changes in the health care system increase the number and complexity of decisions an individual may need to make.

Many individuals receive health care coverage through employer provided health care plans. Health care coverage is expensive and is a major expense for a business. Typically, the more health care that is used, the more the business and individuals need to pay. This is especially true for businesses that are self-insured.

When employees are healthy and happy, they may have less of a need to use the health care system. However, some employees may not understand how to use the health care system and may not engage in a healthy lifestyle. Whereas lower employee use of the health care system may result in lower health care costs for the business, most employees will typically need to use the health care system at some point in their lives. Teaching people how to use the health care system before they need to may be a catalyst for reducing health care costs both in the present and in the future.

### SUMMARY

The present disclosure relates generally to a training system. In some embodiments, and by non-limiting example, the disclosure relates to a training system for educating users about how to use a health care system.

In one aspect, a method of educating a user on a health care system comprises: providing access to a web site using one or more server computing devices; providing access to a plurality of educational topics through the web site, the plurality of educational topics relating to user interaction with and navigation through a health care system, the plurality of educational topics being arranged in a pre-determined sequential order including, in order: pre-event information including information on one or more educational topics that educate the user on how to interact with the health care system before a health care event occurs; active event information including information on one or more educational topics that educate the user on how to interact with the health care system during the occurrence of a health care event; and post-event information including information on one or more educational topics that educate the user on how to interact with the health care system after one or more health care events has occurred.

In another aspect, a method for monitoring health care system training effectiveness for employees of a business comprises: providing health care system topics in a predetermined order; providing content relating to the health care system topics, the content being provided from a server computer through a website; making the content available through the website to train the employees on the health care system topics; providing quizzes related to the health care system topics; making the quizzes available through the website to the employees; compiling results from the quizzes; providing surveys to the employees to receive employee feedback on the content; compiling results from the surveys; and using the results of the quizzes and surveys to evaluate the effectiveness of the training.

In yet another aspect, a server computer comprises a processing unit; and memory, the memory storing instructions that, when executed by the processing unit, cause the server computer to: host a web site that provides a plurality of educational topics; provide access to the plurality of educational topics through the web site, the plurality of educational topics relating to user interaction with and navigation through a health care system, the plurality of educational topics being arranged in a pre-determined sequential order including, in order: pre-event information including information on one or more educational topics that educate the user on how to interact with the health care system before a health care event occurs, the pre-event information including financial information on how to fund health care when the health care event occurs, and information on managing health care records generated during a health care event; active event information including information on one or more educational topics that educate the user on how to interact with the health care system during the occurrence of a health care event, the active event information including: information to assist the user in verifying an illness; information to assist the user in selecting treatment options; information to assist the user in selecting a health care professional; information to assist the user while the user is a patient; and information to assist the user when treatment ends; and post-event information including information on one or more educational topics that educate the user on how to interact with the health care system after one or more health care events has occurred, the post-event information including information on managing prescriptions and information on payment of a bill for the health care event; provide quizzes related to each of the plurality of educational topics; provide access to the quizzes through the website; provide incentives to the user based on the performance on the quizzes; receive survey information from the user regarding the effectiveness of the educational topics; and provide reports summarizing the survey information and the user performance on the quizzes.

### BRIEF DESCRIPTION OF THE DRAWINGS

FIG. 1 shows an example health care system environment.

FIG. 2 shows an example of a training system of the health care system education environment, shown in FIG. 1.

FIG. 3 shows an example home page user interface screen for a training system website.

FIG. 4 shows another example user interface screen for the training system website.

FIG. 5 shows yet another example user interface screen for the training system website.

FIG. 6 shows an example user interface screen for selecting a health care navigation engine.

FIG. 7 shows an example user interface screen for a health care navigation engine of FIG. 6.

FIG. 8 shows an example user interface screen for beginning the health care navigation engine of FIG. 7.

FIG. 9 shows an example user interface screen for playing a video for the health care navigation engine of FIG. 7.

FIG. 10 show an example user interface screen for viewing information for the health care navigation engine of FIG. 7.

FIG. 11 shows an example user interface screen for a quiz for the health care navigation engine of FIG. 7.

FIG. 12 shows another example user interface screen for a quiz for the health care navigation engine of FIG. 7.

FIG. 13 shows yet another example user interface screen for a quiz for the health care navigation engine of FIG. 7.

FIG. 14 shows an example user interface screen for selecting a vital endurance engine.

FIG. 15 shows an example user interface screen for a vital endurance engine of FIG. 14.

FIG. 16 shows an example user interface screen for beginning the vital endurance engine of FIG. 15.

FIG. 17 shows an example user interface screen for a physical activity challenge.

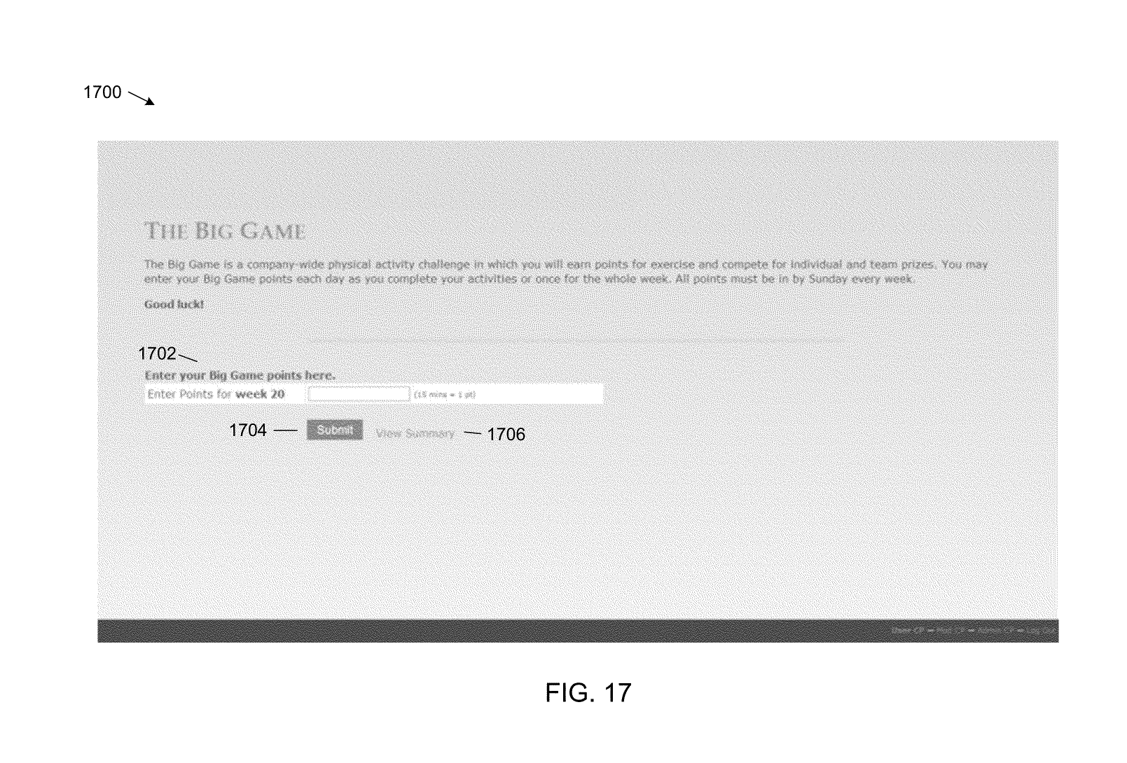

FIG. 18 shows another example user interface screen for the physical activity challenge of FIG. 17.

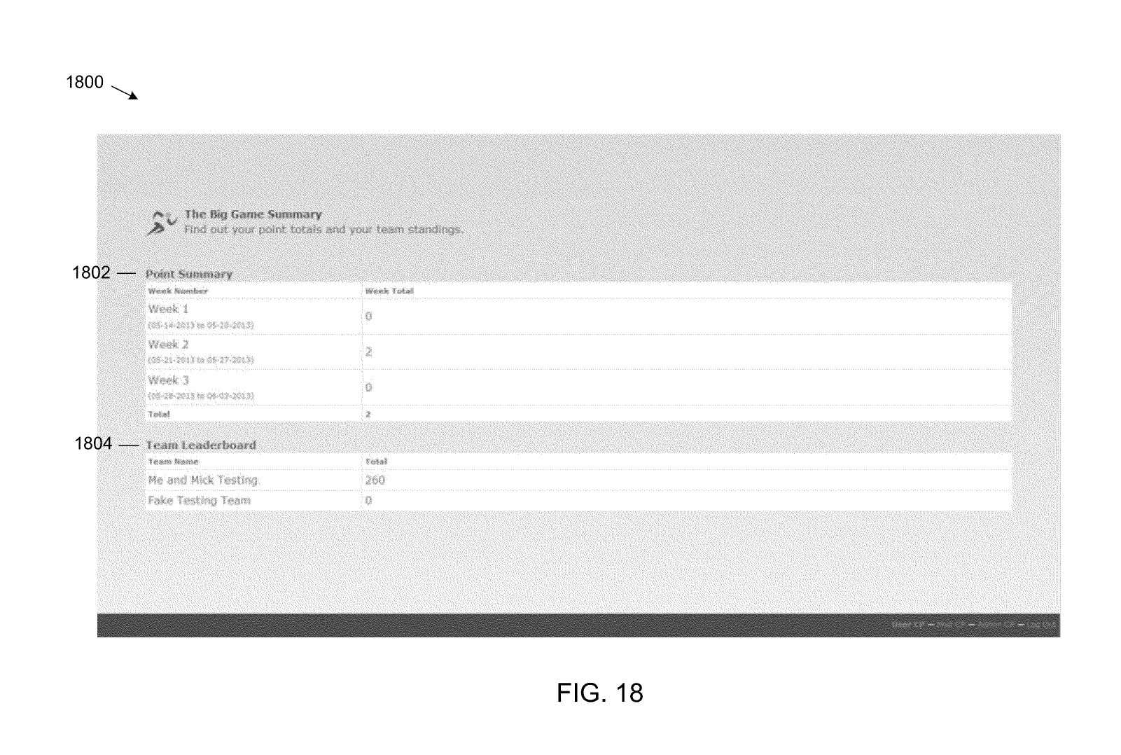

FIG. 19 shows an example flowchart for a method of educating a user on a health care system.

FIG. 20 shows an example sequential order of information.

FIG. 21 shows an example flowchart for a method for monitoring health care system training effectiveness.

FIG. 22 shows example physical components of the web server of FIG. 1.

### DETAILED DESCRIPTION

The health care system is largely based on numerous policies, procedures, and best-practices that define how the various parties involved with the health care system should act in certain circumstances. The parties include, of course, the health care providers, such as physicians and other caregivers, and the patient. But the health care system also includes numerous other parties, including health insurance companies, health care administrators, medical supply and medical device manufacturers, and the like. The policies and procedures are designed for the masses, but cannot address the unique circumstances of each patient. The policies and procedures of the health care system therefore often lead to improper or unnecessary medical care, for example. A patient or health care advocate who is trained to understand the health care system and at least some of these policies and procedures, can be empowered to engage with the system and adjust the processes to beneficially impact costs and outcomes.

The present disclosure is directed to a system and methods for educating individuals and businesses about how to use the health care system in the United States in an efficient and cost effective manner. In addition, the systems and methods may be used to educate individuals and businesses about nutrition and preventative health and about financial issues related to health care. By educating employees about health care and by encouraging and supporting healthy living practices, businesses may help their employees to be happier, healthier and more productive. In addition, if the healthy living practices result in the employees being healthier and using the health care system less, employee health care costs for the business may be reduced.

In an example embodiment, a web-based training program is provided in which individuals can be trained online over the Internet. Some embodiments provide sixteen training modules, for example, relating to navigating the health care system and ten additional modules relating to nutrition and financial security.

In this example the training modules for navigating the health care system include modules relating to 1) an introduction to the health care system, 2) health care champions, 3) funding an individual's health care, 4) managing health information, 5) staying healthy, 6) verifying an illness, 7) selecting treatment options, 8) selecting a health care professional, 9) being a patient, 10) when treatment ends, 11) coordinating care for the patient, 12) managing chronic disease, 13) managing prescriptions, 14) paying the final bill, 15) preparing for emergencies and 16) long-term care.

In some embodiments, the information is arranged in categories. For example, in some embodiments the training modules for navigating the health care system are arranged in categories including: pre-event information, active event information, and post-event information. In some embodiments the information is presented in a sequential order. As one example, the categories are presented in order of pre-event information, active event information, and post-event information.

Examples of the pre-event information include one or more of: an introduction to the health care system, health care champions, funding an individual's health care, managing health information, and staying healthy. Examples of the active-event information include one or more of: verifying an illness, selecting treatment options, selecting a health care professional, being a patient, and when treatment ends. Examples of the post-event information include one or more of: coordinating care for the patient, managing chronic disease, managing prescriptions, and paying the final bill.

Some embodiments include a category of information relating to long-term care and/or chronic illnesses. Examples of long-term care/chronic illnesses information include: coordinating my care, managing chronic disease, and long-term care.

In some embodiments the information is presented in the sequential order in which the information is listed above within one or more of the categories.

The modules related to nutrition include 1) the U.S. food system, 2) the health impact of nutrition, 3) food and your body, 4) nutrients—your body's fuel, 5) healthy dining habits and 6) label reading and smart shopping.

The modules related to financial security include 1) basic financial information, 2) financial counseling and debt management, 3) information about credit scores and 4) retirement and disability benefits information. More, fewer, or different modules may be used for each of the health care system, nutrition and financial security. Modules may be also included for additional topics such as sleep and physical activity.

The modules are designed to be used in a predetermined sequential order, reflecting that use of the health care system is a process. In some embodiments the order corresponds to a) modules related to preparing to use the health care system, b) modules related to being actively engaged in the health care system and c) modules related to post engagement in the health care system. For example for the health care navigation modules, modules 1-5 are related to preparing to use the health care system, modules 6-10 are related to active engagement in the health care system and modules 11-16 are related to post engagement with the health care system.

Quizzes are provided after each of the health care navigation modules and after each of the financial security, sleep and physical activity modules. The quizzes provide a way to test an employees' knowledge of the subject matter of a module. The quizzes provide immediate feedback to the employee and also provide statistics for the business. The statistics may be used to determine the extent to which employees are mastering the subject matter of the modules. In some embodiments, employees may be given a certificate of completion after each quiz. The certificate of completion can be used to prove to the business that an employee has completed a specific module.

In addition, in a business environment, the health care navigation modules, nutrition modules and financial security modules may be presented in a classroom setting for employees of the business. Presenting these modules on site in a business may complement material available online and may provide an opportunity for employees to better learn the information in the modules and to ask questions. Some businesses may also make use of a life services consultant who is trained and knowledgeable about the content of these modules and in organizational change strategies. In some businesses, the life services consultant may teach these modules to the employees of the business. The life services consultant may also identify and train employees to become champions of healthy living. These champions of healthy living are typically employees who are interested in the subject matter of the modules and who are interested in taking a lead role in helping fellow employees learn and master this subject matter. The champions of healthy living are also typically recruited to participate on a life services committee and in a weight management and health lifestyle support group.

Some businesses may also implement organized individual and group exercise projects for the company. The group activities, as explained later herein, may provide additional motivation for employees to exercise and may provide incentives based on competition and results.

Businesses may also use financial or other incentives to encourage employees to learn the subject matter of the modules. The combination of online or onsite training modules combined with an organized physical activity program, a life services consultant, a commitment from upper management plus incentives for employees to participate and succeed typically produces better results than a less comprehensive model.

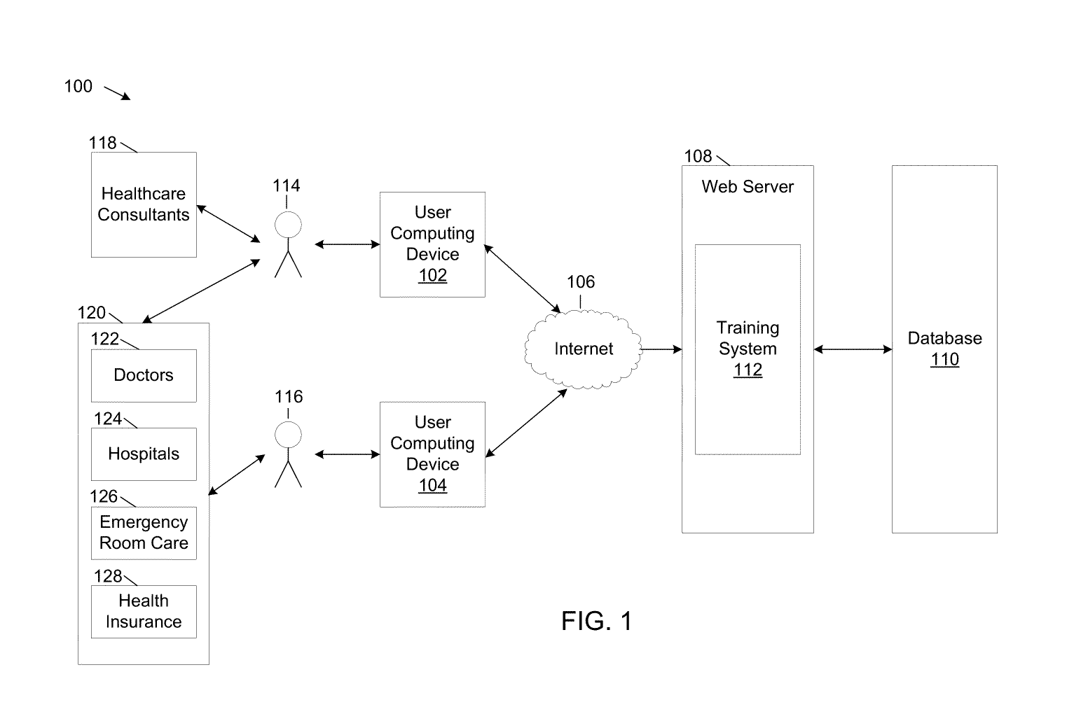

FIG. 1 illustrates an example health care system environment 100 according to the present disclosure. The health care system environment 100 includes one or more health care systems, such as the health care system 120, which provide care to users and may also provide payment for the health care provided by the system 120. Often the health care system involves numerous laws, regulations, contractual provisions, and procedures that need to be navigated by both the user and the care providers.

The health care system environment 100 also includes a training system 112 that operates to educate the users 114,116 on aspects of the health care system 120. Once educated, the users 114,116 can more easily navigate through the health care system 120.

In the example illustrated in FIG. 1, the health care system environment 100 includes user computing devices 102, 104, data communication network 106, web server 108, database 110 and training system 112. More or fewer user computing devices, web servers, and databases may be used. In some embodiments, one or more mobile computers, for example tablet computers and smart telephones, may be used.

The health care system environment 100 also includes health care system users 114, 116, health care consultants 118, and an example health care system 120. In the example health care system environment 100, user 114 is an employee of a business and user 116 is an individual user.

A business user 114 on user computing device 102 or an individual user 116 on user computing device 104 may access a training system website from user computing device 102 or user computing device 104, respectively. A user interface for the training system website is received from web server 108 via the data communication network 106, and rendered on user computing device 102 or on user computing device 104. An example of the network 106 is the Internet, which may include multiple different data communication networks that operate together to permit data communication through and between the various networks. As discussed in detail later herein, the user interface permits business user 114 and individual user 116 to access one or more training modules.

The web server 108 includes training system 112. In some embodiments, the training system 112 operates to educate the user 114, 116 through a series of training modules. Training module information may be stored on web server 108, on database 110 or on a combination of web server 108 and database 110.

A business may also make use of health care consultants 118. The health care consultants 118 are life services consultants hired by the business to organize and help implement the training system 112 at the business. The health care consultants 118 are typically trained and knowledgeable in health care issues and in the operation of the training system 112. The health care consultants 118 may teach onsite classes on the training modules, may help answer employee questions, may recruit and train health care champions at the business and may help implement one or more physical training programs for employees of the business. Other uses of the health care consultants 118 are possible.

When the business user 114 and the individual user 116 learn the content of the training modules, the business user 114 and individual user 116 may be better able to navigate and use the health care system 120. As shown in FIG. 1, the health care system 120 includes, for example, doctors 122, hospitals 124, emergency room care 126 and health insurance 128. Other aspects of the health care system are possible and are not shown in FIG. 1.

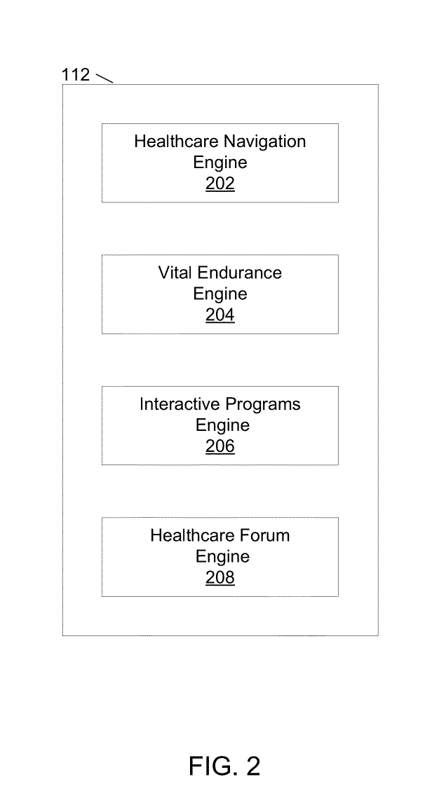

FIG. 2 shows an example of the training system 112. In this example, the training system 112 includes a health care navigation engine 202, a vital endurance engine 204, an interactive programs engine 206 and a health care forum engine 208.

The health care navigation engine 202 provides content through a set of health care navigation training modules that educate the user 114, 116 on topics relating to navigating the health care system. In some embodiments, the health care navigation training modules present the content through a video presentation, through written content and through interactive scenario based learning. The content provided by each health care navigation training module relates to the topic of the respective training module. The health care navigation engine 202 also controls a user interface, explained later herein, for accessing the training modules.

In some embodiments, the health care navigation training modules include topics that provide an introduction to health care system, and also provide information related to finding doctors and hospitals, being diagnosed and treated for an illness, understanding health information and medical records, staying healthy and long term care. Other topics are possible.

The vital endurance engine 204 provides content through a set of nutrition training modules that educate the user 114, 116 on topics relating to nutrition and a set of financial security training modules that educate the user 114, 116 on topics relating to financial security. Additional training modules educate the user 114, 116 on topics relating to physical activity and sleep issues. Other training modules are possible. In some embodiments, the nutrition and financial security training modules present the content through a video presentation as well as through written content. The vital endurance engine 204 also controls a user interface, explained later herein, for accessing the nutrition and financial security training modules.

In some embodiments, the nutrition training modules provide an introduction to the U.S. food system, discuss aspects of nutrition, discuss healthy eating habits and discuss label reading and smart shopping. Other nutrition topics are possible. In some embodiments, the financial security training modules include topics on managing money, financial counseling, debt management, credit scores and retirement and disability benefits. Other financial security topics are possible.

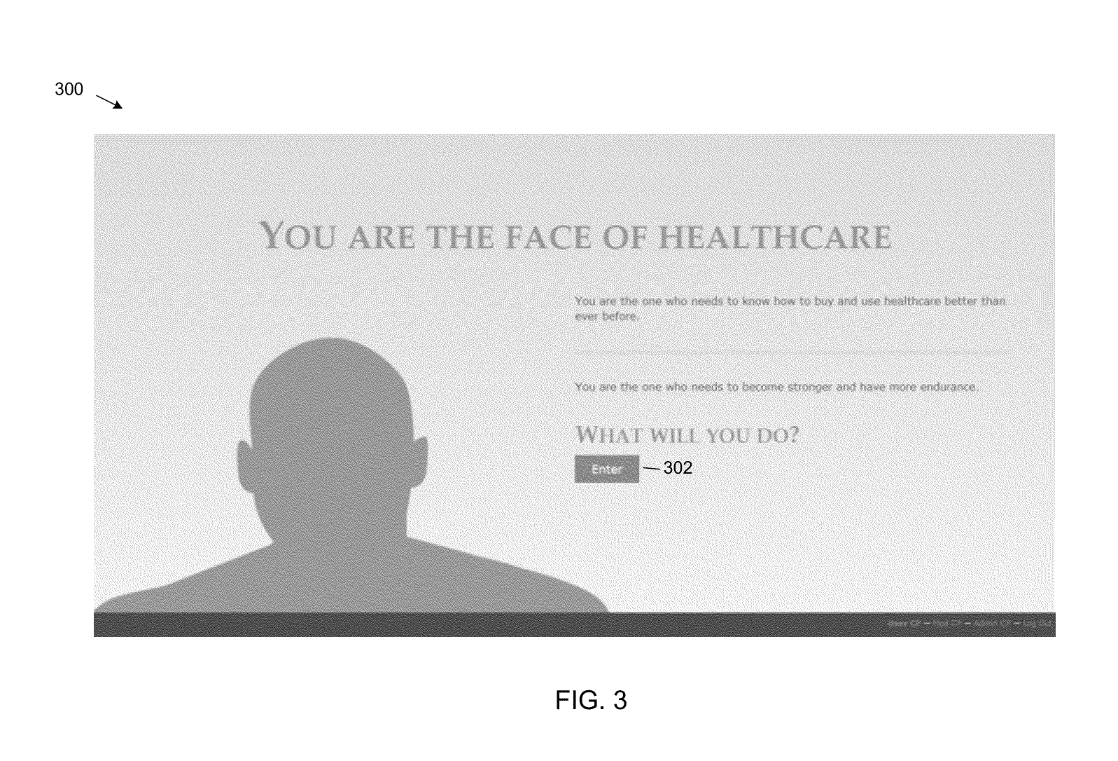

FIG. 3 shows an example user interface screen 300 that may be displayed when the business user 114 or the individual user 116 accesses the training system website rendered by web server 108. The following discussion describes actions taken by business user 114 on user computing device 102. These actions may also apply to individual user 116 on user computing device 104.

The user interface screen 300 provides a home page for the training system website and includes an Enter button 302 for entering the website. When the business user 114 selects the Enter button 302, the example user interface screen 400 is displayed on user computing device 102.

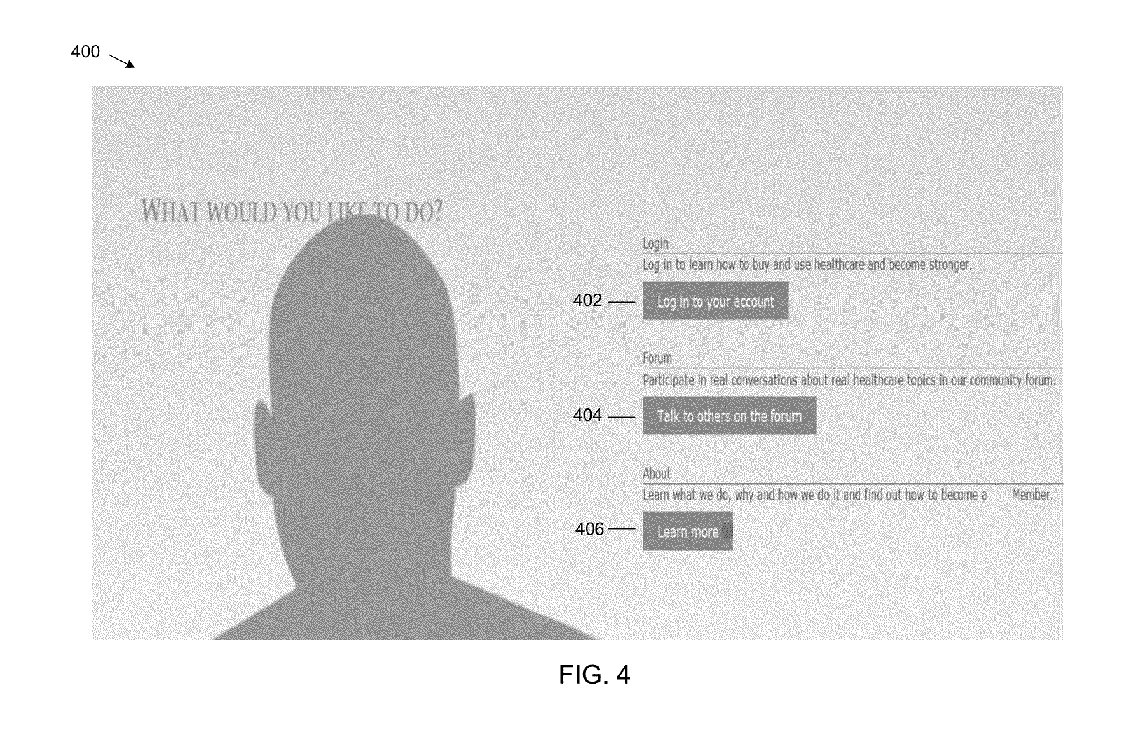

The user interface screen 400, shown in FIG. 4, provides three choices for business user 114. The business user 114 may either login to the training system website, participate in an online forum about health care topics or learn more about the training system 112 and about membership in the training system 112. To login to the training system website, the business user 114 selects the Log in to your account button 402. To participate in an online forum, the Talk to others on the forum button 404 is selected. The online forum provides a way for users of the training system website to make comments and ask questions of other users of the training system website. To learn more about the training system 112, the Learn more button 406 is selected.

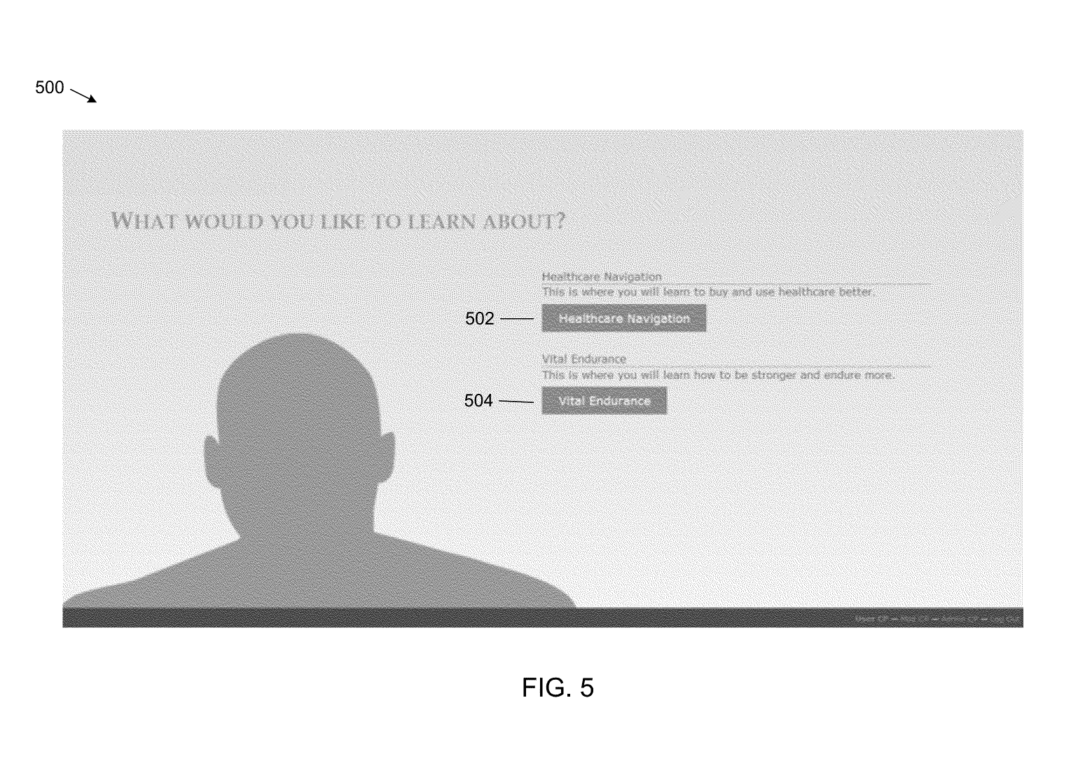

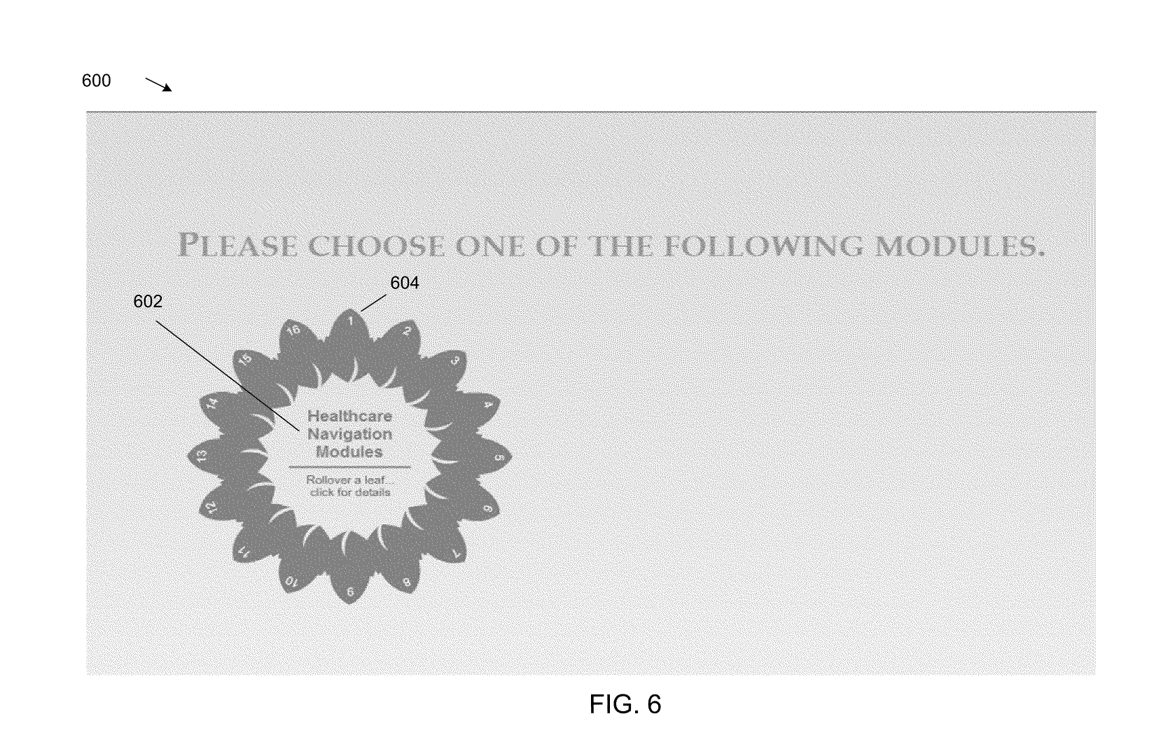

When the business user 114 selects the Log in to your account button 402 and logs on, an example user interface screen 500 is displayed. The user interface screen 500, shown in FIG. 5, permits the business user 114 to select whether to learn about health care navigation or vital endurance. Selecting health care navigation provides information about buying and using health care better. Selecting vital endurance provides information on nutrition, physical activity, sleep and financial security. A Health care Navigation button 502 and a Vital Endurance button 504 are provided. When the Health care Navigation button 502 is selected, a user interface screen 600, shown in FIG. 6, is displayed.

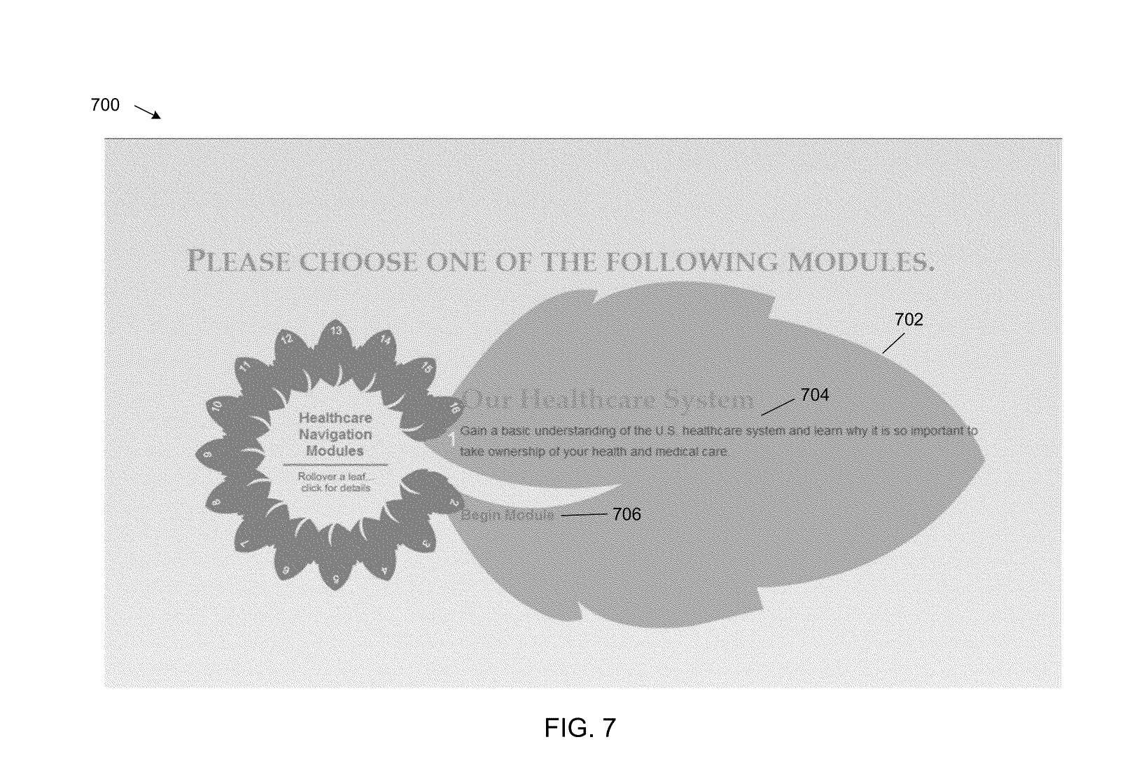

The example user interface screen 600 provides a selectable interface for selecting among 16 health care navigation modules. In the user interface screen 600, the 16 health care navigation modules are shown in a leaf mechanism 602. Each of the 16 health care navigation modules is numbered and is represented as a leaf in the leaf mechanism. Selection of a leaf, typically performed by clicking on a leaf, provides details on the selected module. For example, selection of leaf 604 provides details for health care navigation engine 1. The leaf mechanism 602 is just one mechanism that may be used for permitting module selection. Different types of mechanisms may be used. More or fewer than 16 health care navigation modules may be provided for selection. When leaf 604 is selected, a user interface screen 700, shown in FIG. 7 is displayed.

The example user interface screen 700 is a home page for health care navigation engine 1—Our Health care System. As shown in FIG. 7, leaf 604 opens up and rotates into a larger leaf 702. Leaf 702 includes a title of health care navigation engine 1 (Our Health care System) and an introduction 704 to health care navigation engine 1. The example introduction 704 states “Gain a basic understanding of the U.S. health care system and learn why it is so important to take ownership of your health and medical care. Other introductions may be used for health care navigation engine 1 and for any of the other health care navigation and vital endurance engines.

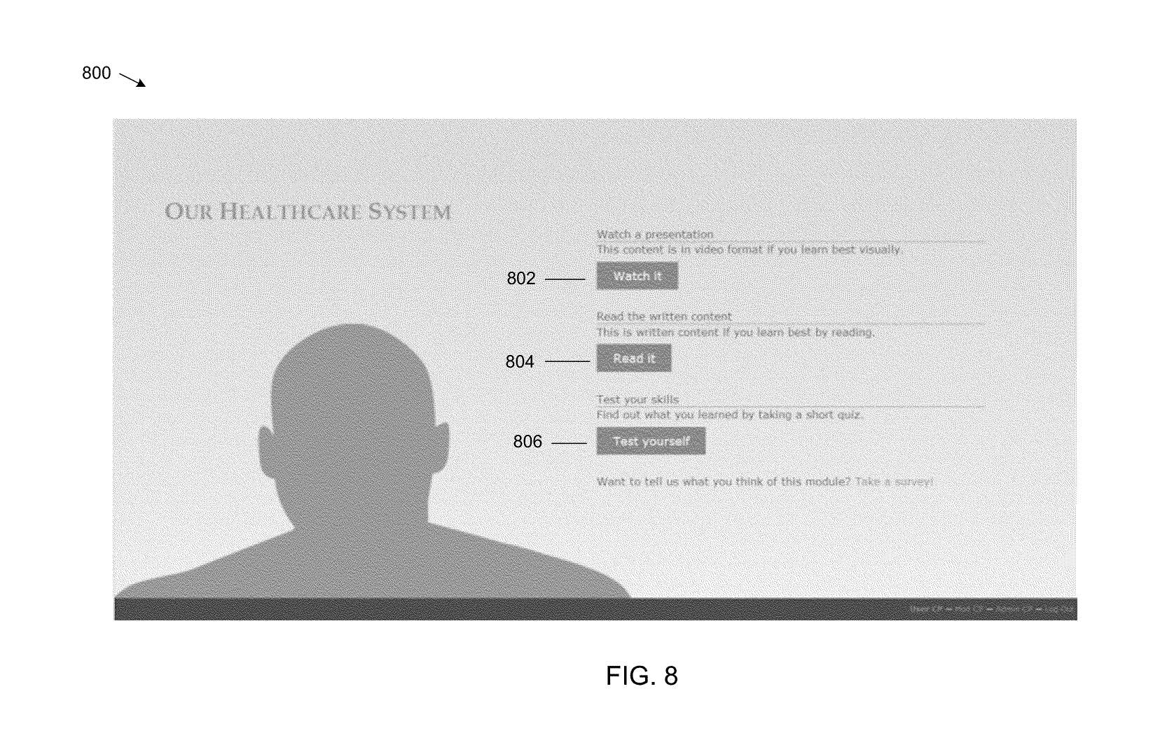

To begin health care navigation engine 1, a Begin Module link 706 is selected. When the Begin Module link 706 is selected, a user interface screen 800, shown in FIG. 8 is displayed.

The example user interface screen 800 gives business user 114 a choice of two ways to learn the content of health care navigation engine 1—visual or text. The business user 114 may watch a video of the content or may view written content. The video format is best for someone who learns best visually and the written content is best for someone who learns best by reading. The user interface screen 800 also provides access to a quiz on the content of health care navigation engine 1.

The user interface screen 800 includes a Watch it button 802, a Read it button 804 and a Test yourself button 806. The Watch it button 802 is used to select the video format, the Read it button 804 is used to select the text format and the Test yourself button 806 is used to select the quiz.

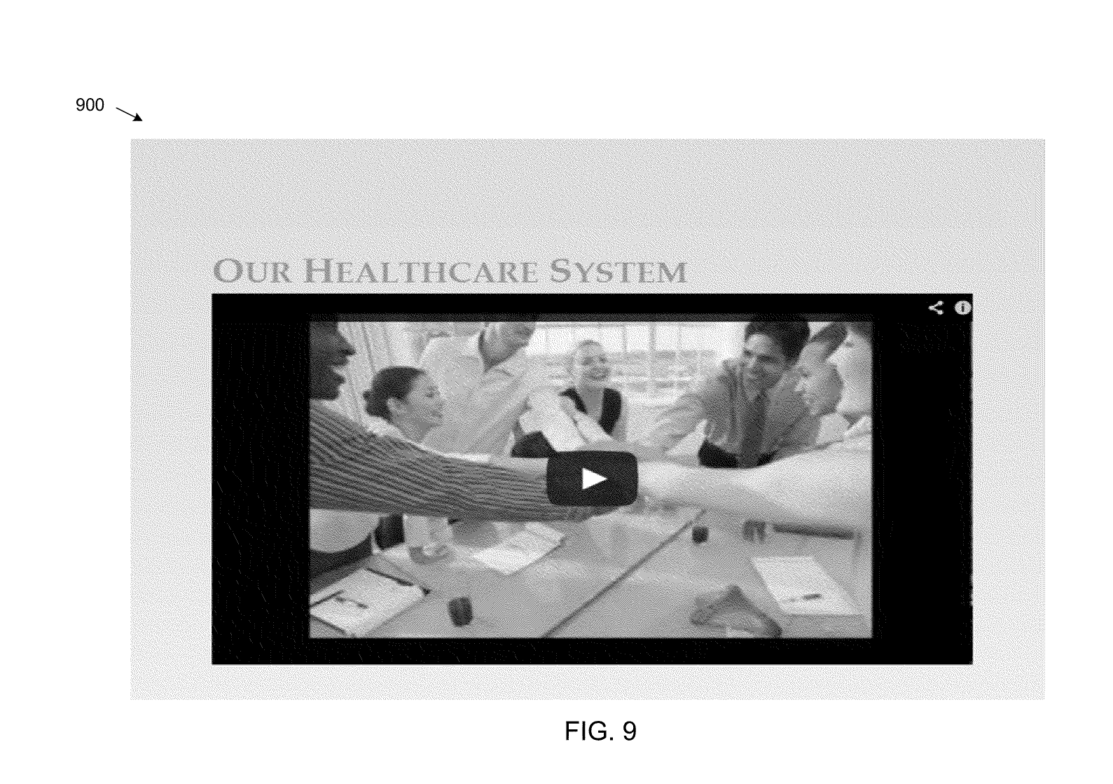

When the Watch it button 802 is selected, an example user interface screen 900, shown in FIG. 9 is displayed. The user interface screen 900 provides access to a video on “Our Health care System.”

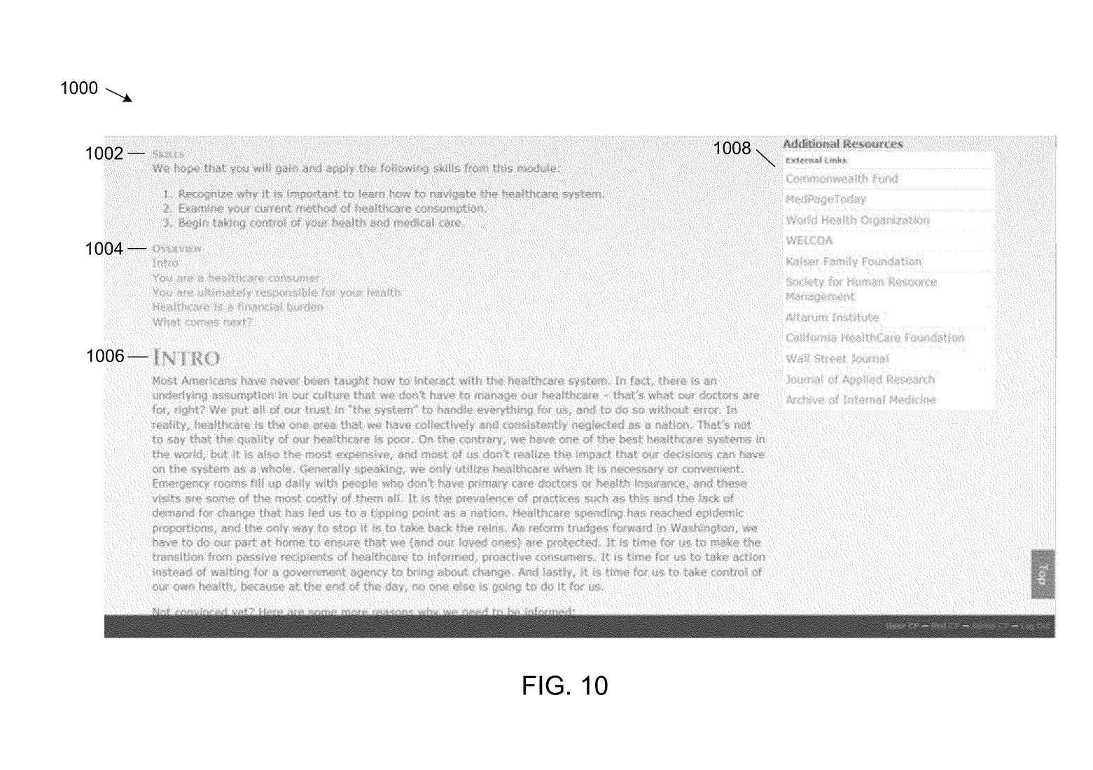

When the Read it button 804 is selected, an example user interface screen 1000, shown in FIG. 10 is displayed. The user interface screen 1000 is a part of an example written (e.g., text-based) document on “Our Health care System.” The written document includes a skills section 1002, an overview section 1004, an introduction section 1006 and an additional resources section 1008. Written documents for other health care navigation modules include similar sections.

The skills section 1002 lists example skills to be gained from health care navigation engine 1. For health care navigation engine 1, the skills to be learned include 1) recognizing why it is important to learn how to navigate the health care system, 2) examining your current method of health care consumption and 3) beginning taking control of your health and medical care. Other skills for health care navigation engine 1 are possible.

The overview section 1004 includes section headings for health care navigation engine 1. The example section headings include 1) Intro, 2) You are a health care consumer, 3) You are ultimately responsible for your health, 4) Health care is a financial burden and 5) What comes next? Other section headings for health care navigation engine 1 are possible.

The additional resources section 1008 provides links for additional resources for the subject matter of health care navigation engine 1. Example links are for the commonwealth fund, med page today and the world health organization. Other links are shown in FIG. 10. More, fewer or different links are possible.

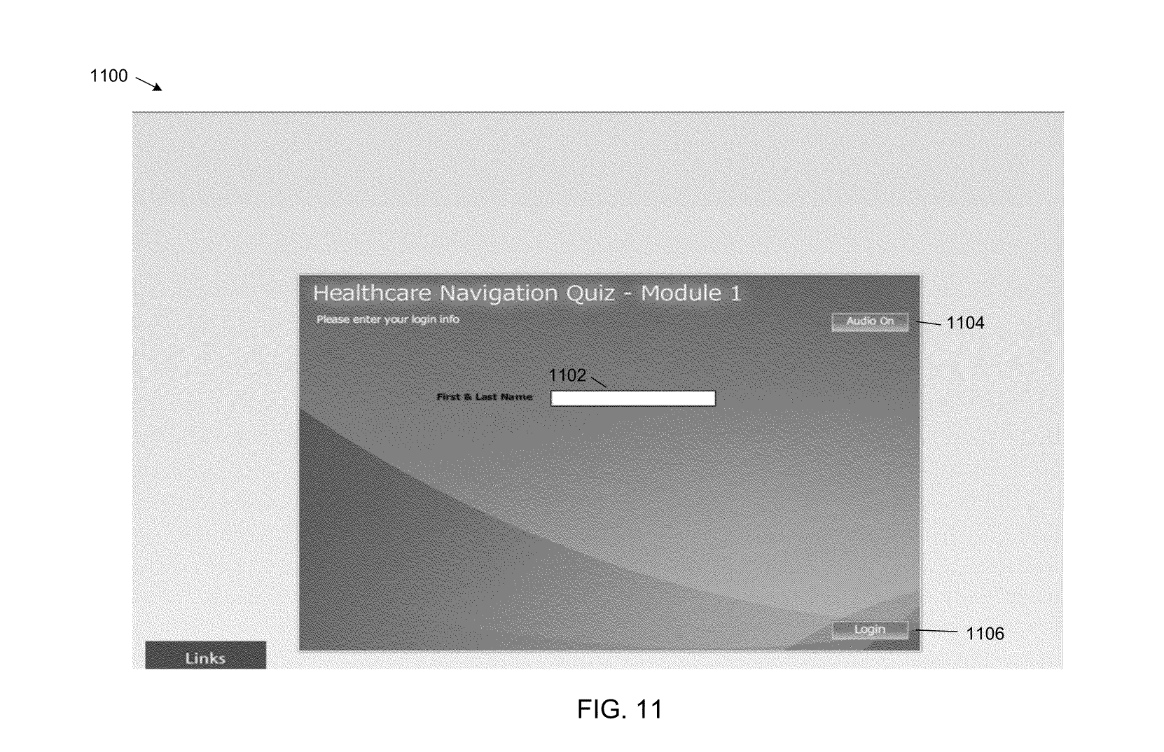

When the Test yourself button 806 is selected, an example user interface screen 1100, shown in FIG. 11, is displayed. The user interface screen 1100 permits a login to a health care navigation quiz for health care navigation engine 1. A text box 1102 is included for entering login information for the business user 114. An audio on button 1104 and a login button 1106 are also provided. The business user 114 enters his/her first and last name in the text box 1102. The audio on button 1104 is selected if the business user 114 wants the test questions to be read aloud to the business user 114.

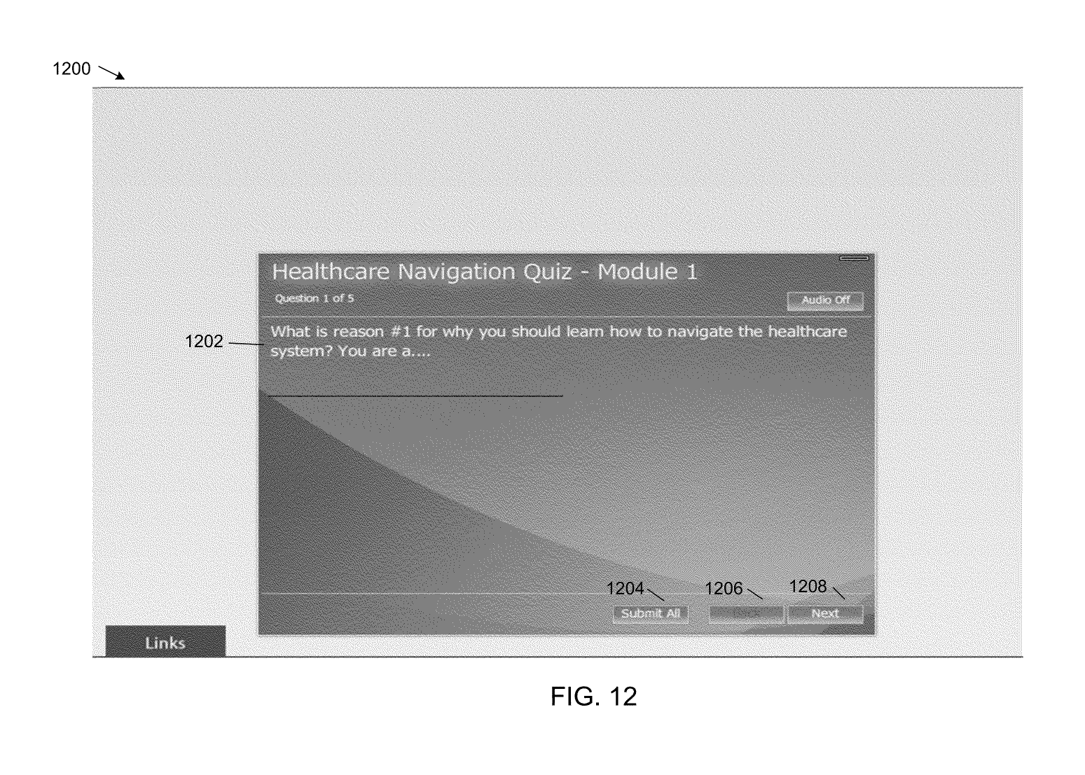

When the login button 1106 is selected, an example user interface screen 1200, shown in FIG. 12, is displayed. The user interface screen 1200 shows an example quiz question 1202. The quiz question 1202 is an open ended question whereby the business user 114 provides an answer that completes a question. The example quiz question 1202 is “What is reason #1 for why should learn how to navigate the health care system? The business user 114 then must complete the sentence “You are a . . . ” The business user 114 submits an answer to quiz question 1202 by selecting the Submit All button 1204. If the business user 114 is not yet comfortable to the answer to quiz question 1202, the user may skip to the next question by selecting the Next 1208 button or go back to a previous question by selecting the Back button 1206.

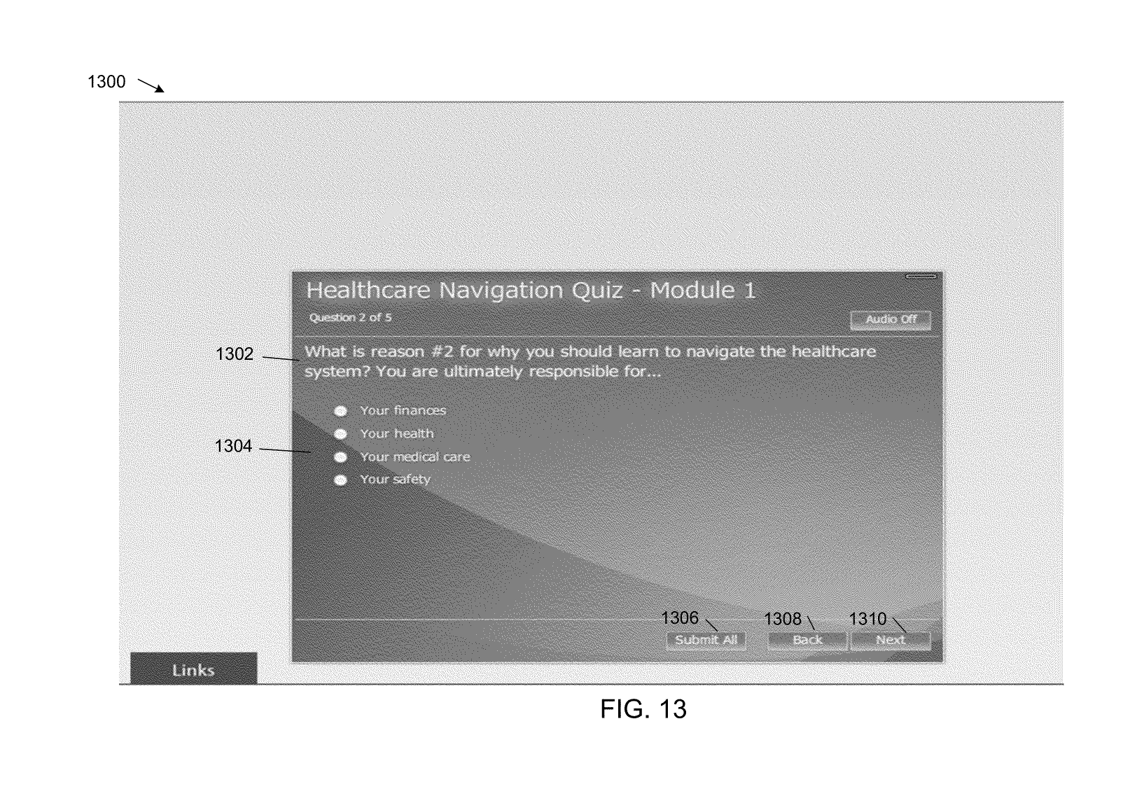

FIG. 13 shows an example user interface screen 1300. The user interface screen 1300 provides an example of a multiple choice question 1302. The example multiple choice question 1302 is “What is reason #2 for why you should learn to navigate the health care system?” Example multiple choice answers 1304 are provided. The business user 114 can choose from 1) your finances, 2) your health, 3) your medical care and 4) your safety. After one of the multiple choice answers is selected, the business user 114 can select one of the Select All button 1306, the Back button 1308 or the Next button 1310.

Referring back to FIG. 6 now, the business user 114 can select another health care navigation engine. The health care navigation engines may be selected in any order, although it is usually preferable to select the health care navigation engines in a sequential order. When a health care navigation engine is selected (by selecting a leaf corresponding to the health care navigation engine), a user interface screen similar to user interface screen 700 of FIG. 7 is displayed. Each such user interface screen shows an enlarged leaf, similar to leaf 702, provides a brief summary of the module contents and permits the business user to begin the module. In addition, each health care navigation engine provides a user interface screen with options for viewing a video, reading content and testing, similar to user interface screen 800.

The content of each health care navigation engine is different. For health care navigation engine 2—“Health care Champions,” the example introduction to health care navigation engine 2 is “Learn what a health care champion is and determine how to find or become one.” The skills to be gained and applied from health care navigation engine 2 are: 1) recognizing the value of health care champions; 2) identifying the various factors involved in either selecting or becoming a health care champion; and 3) selecting a health care champion for yourself or to server as a health care champion for a loved one. The content overview includes 1) defining health care champions; 2) selecting a health care champion; and 3) becoming a health care champion.

For health care navigation engine 3—“Funding My Care,” the example introduction is “Find the health insurance plan that is right for you and learn how to prepare financially for medical expenses.” The skills to be gained and applied from health care navigation engine 3 are: 1) exploring various health benefit options available and being able to discuss them using industry terms; 2) selecting a health plan that is right for you and your family; 3) maximizing benefits in order to avoid unnecessary costs and receive the best possible care; 4) preparing financially for health expenses; and 5) preparing for health reform changes. The content overview includes 1) insurance terms to know; 2) common insurance questions; 3) private health insurance options; 4) public health insurance options; 5) other funding options; and 6) impact of health reform.

For health care navigation engine 4—“Managing My Health Information,” the example introduction is “Know your rights to your medical information and learn how and why to keep track of your health history.” The skills to be gained and applied from health care navigation engine 4 are: 1) identifying your rights to your medical information and privacy; 2) managing your own health information by creating personal health records and keeping track of your medical records; and 3) taking ownership of your health information and becoming a more proactive health care consumer. The content overview includes 1) description of health information; 2) legislation and definitions; 3) know your rights; 4) common “how to” questions; and 5) your personal health record.

For health care navigation engine 5—“Staying Healthy,” the example introduction is “Learn how to avoid getting sick by making healthy choices and utilizing preventative care services through your health plan.” The skills to be gained and applied from health care navigation engine 5 are: 1) recognizing the importance of preventative care and a healthy lifestyle in avoiding illness; 2) identifying your own health risks and steps you can take to reduce those risks; 3) finding out the preventative services that are covered under your health insurance policy and starting to utilize them; and 4) improving or maintaining your health by creating healthy habits and getting preventative care. The content overview includes 1) primary prevention; and 2) secondary prevention.

For health care navigation engine 6—“Verifying My Illness,” the example introduction is “Know when you should get a second opinion and learn how to make informed decisions about your treatment or care.” The skills to be gained and applied from health care navigation engine 6 are: 1) recognizing when second opinions may be helpful or necessary for your care; 2) identifying your options for second opinions, including how to fund them with insurance; 3) comparing medical opinions; and 4) making informed decisions about your care. The content overview includes 1) defining second opinions; 2) preparing for a second opinion consultation; and 3) comparing first and second opinions.

For health care navigation engine 7—“Selecting Treatment Options,” the example introduction is “Learn what questions to ask your doctor and where to find more information before deciding on a course of treatment.” The skills to be gained and applied from health care navigation engine 7 are: 1) recognizing the difference between conventional and complementary medicine; 2) discussing treatment options in depth with your doctor or specialist and coming prepared with questions; 3) conducting research on your own regarding your treatment or care; and 4) preparing for end-of-life care and determining the best options for you and your loved ones. The content overview includes 1) questions and considerations; 2) conventional vs. complementary medicine; and 3) options for end-of-life care.

For health care navigation engine 8—“Selecting a Health care Professional,” the example introduction is “Know the different types of health care professionals and learn how to research and choose one or a medical facility.” The skills to be gained and applied from health care navigation engine 8 are: 1) defining the role of the specialist and explaining how they differ from general care practitioners; 2) conducting your own research on health care professionals and facilities—including rating systems and complaints—before making a decision; and 3) making thoughtful, careful selections when seeking health care professionals and facilities. The content overview includes 1) types of health care professionals; 2) ratings for doctors and hospitals; and 3) finding a specialist.

For health care navigation engine 9—“While I Am a Patient,” the example introduction is “Know your rights as a patient and learn now to make the most of your doctor's visits and hospital stays.” The skills to be gained and applied from health care navigation engine 9 are: 1) compiling a list of “do's” and “don'ts” for doctor's visits or hospital stays; 2) identifying your rights as a patient and knowing resources available to you during your hospital stay; 3) having honest discussions about your treatment and condition with your health care professional and coming prepared to make the most of your appointments; and 4) enlisting help when needed in the form of a health care champion. The content overview includes 1) “do's” and “don't” of health care appointments, 2) doctor's visits; and 3) hospital stays.

For health care navigation engine 10—“When My Treatment Ends,” the example introduction is “Learn how to transition back to normal life following a treatment or procedure and identify potential warning signs.” The skills to be gained and applied from health care navigation engine 10 are: 1) compiling a list of questions to ask your doctor upon your discharge and at your follow-up appointments; 2) making a smooth transition back to your normal life following a procedure, treatment or other form of inpatient care; 3) avoiding common patient mistakes; and 4) identifying critical symptoms or warning signs and know how to communicate them effectively to your health care professionals. The content overview includes 1) leaving the hospital or clinic; 2) follow-up appointments; and 3) rehabilitative care.

For health care navigation engine 11—“Coordinating My Care,” the example introduction is “Know what a medical team is and learn how to assemble the best team to manage and coordinate your care.” The skills to be gained and applied from health care navigation engine 11 are: 1) defining medical teams and care coordination; 2) identifying characteristics of a successful medical team and being able to assemble one for you or a loved one; and 3) maintaining updated health records and constant, open communication with all medical team members. The content overview includes 1) medical teams; and 2) care coordination.

For health care navigation engine 12—“Managing Chronic Disease,” the example introduction is “Learn how to adjust to life with a chronic disease; and understand both the challenges associated with it and the resources available for help. The skills to be gained and applied from health care navigation engine 12 are: 1) understanding and defining the following terms: treatment summary, pre-existing condition, disease management program and medical home; 2) compiling a list of resources and care options available to you; 3) managing your condition effectively and adjusting to a new lifestyle; and 4) finding insurance coverage for your medical expenses. The content overview includes 1) understanding chronic disease; 2) treatment help; and 3) other considerations.

For health care navigation engine 13—“Managing Prescriptions,” the example introduction is “Understand the prescription process, learn how to read prescription drug labels and possibly reduce your medication costs.” The skills to be gained and applied from health care navigation engine 13 are: understanding and defining certain prescription terms; 2) comparing the similarities and differences of generic and name-brand drugs; 3) reading and understanding over-the-counter and prescription drug labels; 4) identifying potential hazards associated with medications; 5) having informed dialogues about your prescription medicine with your provider and/or pharmacist; and 6) examining your options for funding prescriptions through your health plan and potentially reducing costs. The content overview includes 1) types of medications; and 2) prescriptions and the pharmacy; drug safety; and other considerations.

For health care navigation engine 14—“Paying the Final Bill,” the example introduction is “Understand the medical billing process and learn how to select a payment option, file a dispute or negotiate a price.” The skills to be gained and applied from health care navigation engine 14 are: 1) understanding the billing process and verifying the accuracy of your medical bills; 2) filing disputes regarding medical bill errors or insurance coverage issues when it is appropriate to do so; 3) paying or negotiating medical bills without undue stress; 4) knowing the options available to you if you need assistance paying your medical bills; 5) serving as your own billing advocate but also recognizing when to seek help from outside resources. The content overview includes 1) understanding the billing process; 2) negotiating rates; 3) handling errors and disputes; and 4) paying off medical debt.

For health care navigation engine 15—“Preparing for Emergencies,” the example introduction is “Learn how to prepare for and take action in emergency situations, whether it is you or someone else who needs help.” The skills to be gained and applied from health care navigation engine 15 are: 1) preparing for potential emergency situations by compiling necessary paperwork, setting end-of-life wishes, building a first aid kit and examining your health plan for emergency payment options; 2) taking the lead in emergency situations by administering basic care to those in need and preparing for the arrival of paramedics; 3) communicating effectively and concisely with emergency personnel (911 dispatchers, paramedics, etc.). The content overview includes 1) getting started; 2) prepping for emergencies; 3) warning signs and symptoms; 4) responding to emergency situations; and 5) assisting emergency personnel.

For health care navigation engine 16—“Long-term Care,” the example introduction is “Learn how to compare different long-term care options and choose one that works best for you or your loved one. The skills to be gained and applied from health care navigation engine 16 are: 1) recognizing the signs that long-term care may be necessary; 2) listing and comparing the different types of long-term care; 3) being ready to select a long-term care option that meets your needs or the needs of your loved one based on informed choices; 4) learning about ways to finance long-term care and explore ways to reduce costs through insurance plans or other resources; 5) start to prepare an advanced directive and list of end-of-life wishes for yourself or a loved one. The content overview includes 1) defining long-term care; 2) long-term care options; 3) selecting a long-term care provider; 4) paying for long-term care; and 5) setting end-of-life wishes.

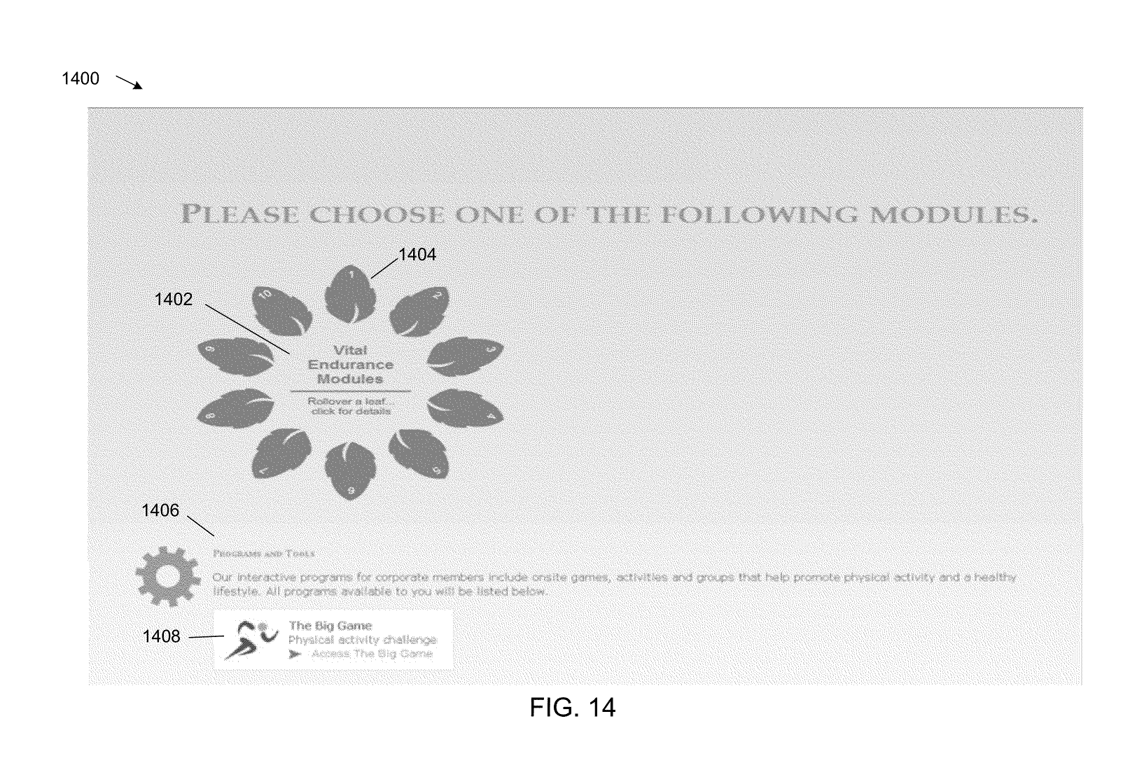

Now referring back to FIG. 5, when the Vital Endurance button 504 is selected, an example user interface screen 1400, shown in FIG. 14, is displayed.

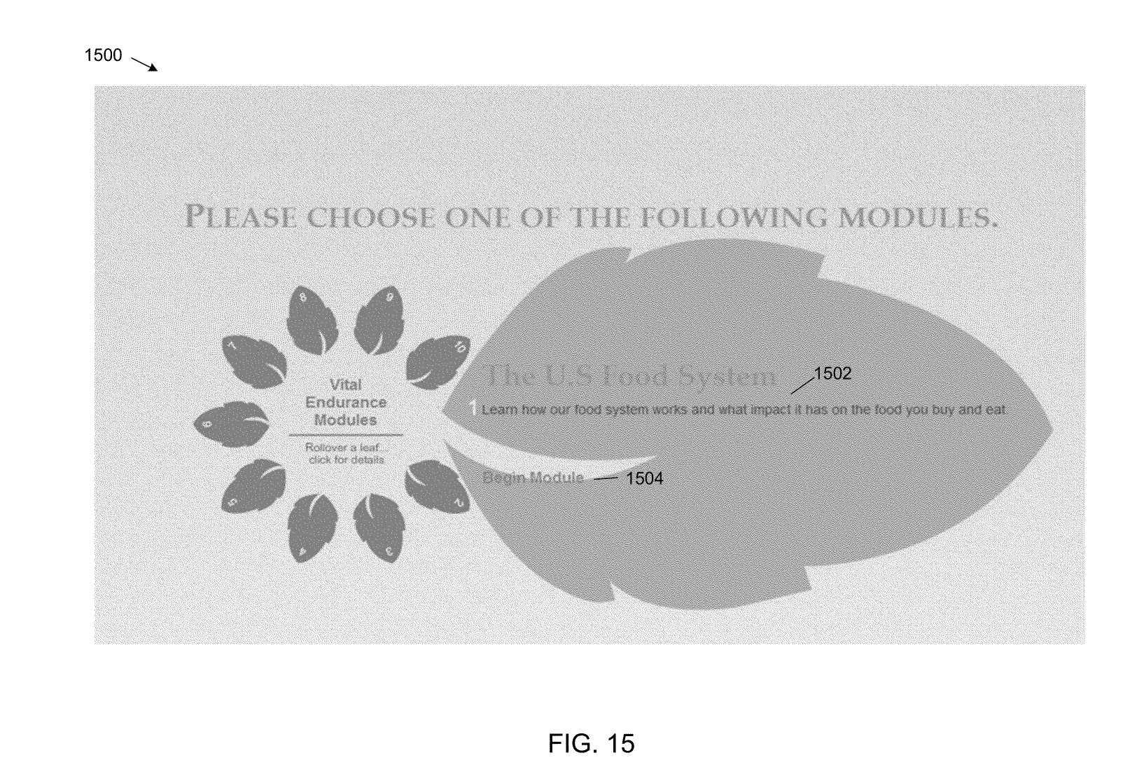

The user interface screen 1400 provides a means for selecting the 10 vital endurance engines. For the user interface screen 1400, the 10 vital endurance engines are shown in a leaf mechanism 1402. Each of the 10 vital endurance engines is numbered and is represented as a leaf in the leaf. Selection of a leaf provides details on the selected module. For example, selection of leaf 1404 provides details for vital endurance engine 1. The leaf mechanism 1402 is just one mechanism that may be used for permitting module selection. Different types of mechanisms may be used. More or fewer than 10 vital endurance engines may be provided for selection. When leaf 1404 is selected, a user interface screen 1500, shown in FIG. 15 is displayed.

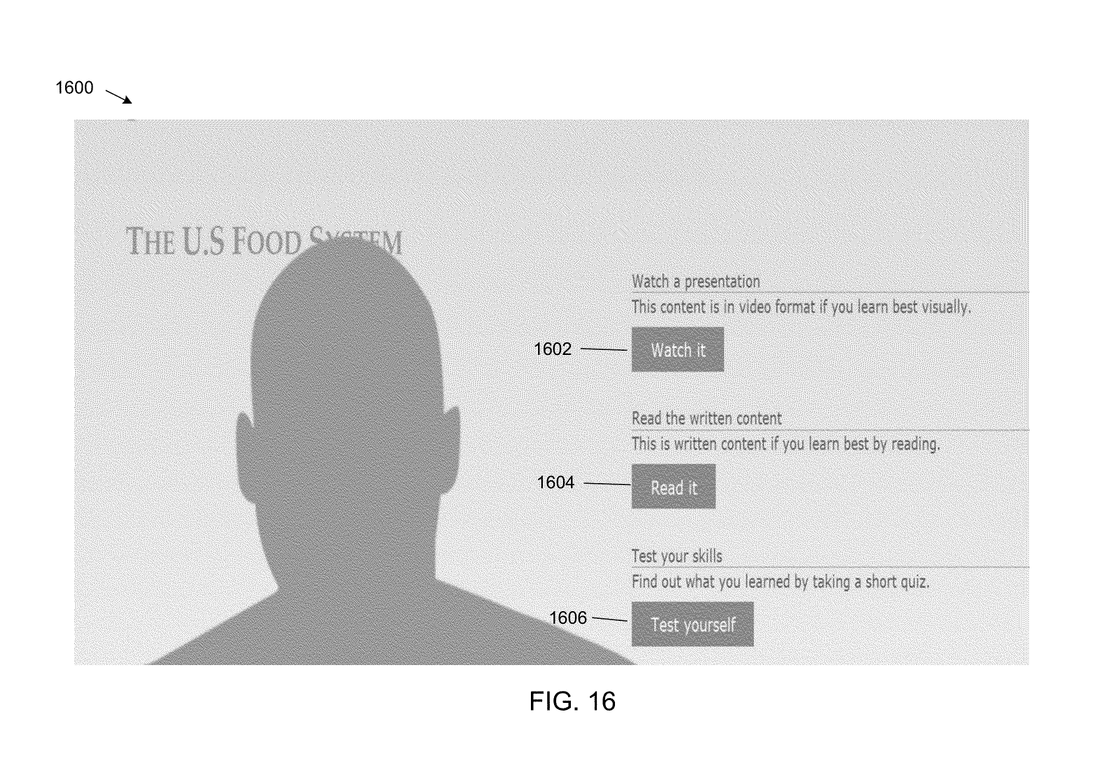

In a similar manner to the health care navigation engines 202 (, each time a vital endurance engine is selected, a user interface screen similar to user interface screen 1500 is displayed. The user interface screen 1500 includes the title of vital endurance engine 1—“The U.S. Food System”—and also an example description of vital endurance engine 1. The example description is “Learn how our food system works and what impact it as on the food you buy and eat.” The user interface screen 1500 also includes a Begin Module link 1504. When the Begin Module link 1504 is selected, the user interface screen 1600, shown in FIG. 16 is displayed.

The example user interface screen 1600 provides two ways to learn the content of vital endurance engine 1—visual or text, similar to the user interface screen 800 for health care navigation engine 1. The user interface screen 1600 includes a Watch it button 1602, a Read it button 1604 and a Test yourself button 1606. The Watch it button 1602 is used to select the video format, the Read it button 1604 is used to select the text format and the Test yourself button 1606 is used to select a quiz. When the Watch it button 1602 is selected, a user interface screen (not shown) is displayed that provides access to a video on “The U.S. Food System.” When the Read it button 1604 is selected, a user interface screen (not shown) is displayed that provides text documentation of “The U.S. Food System.” When the Test yourself button 1606 is selected, a user interface screen (not shown) is displayed that provides a quiz on vital endurance engine 1. Typically, several quizzes are provided, each using a separate user interface screen.

In a similar manner to the health care navigation engines, text documentation for each vital endurance engine includes a skills section, an overview section and an additional resources section. The additional resource section includes links for accessing additional information on a vital endurance engine.

For vital endurance engine 1 on the U.S. food system, the skills to be gained are: 1) recognizing the importance of good nutrition and the impact of the food system on our diets; 2) making informed food purchasing decisions with an increased knowledge of where foods come from; and 3) being able to find and purchase nutritious food through the supermarket, local farmers market or other source. The content overview includes 1) history of the food system; and 2) impact of the food system.

For vital endurance engine 2—“The Health Impact of Nutrition,” the example overview is “Learn the elements of a healthy diet and the benefits of good nutrition.” The skills to be gained are: being able to recognize the health benefits of good nutrition and the health risks of poor nutrition; and 2) identifying the elements of a healthy diet. The content overview includes 1) elements of a healthy diet; and 2) health risks of poor nutrition.

For vital endurance engine 3—“Food and Your Body,” the example overview is “Learn how your body processes and uses the foods you eat.” The skills to be gained are: 1) understanding the digestion and absorption process; 2) realizing the impact of nutrition on your body's daily functions and the importance of a healthy balanced diet; 2) taking steps to maintain a healthy digestive system. The content overview includes 1) nutrient absorption; and 2) the digestive system.

For vital endurance engine 4—“Nutrients—Your Body's Fuel,” the example overview is “Learn more about the nutrients your body needs to function and thrive.” The skills to be gained are: 1) recognizing the importance of a nutrient-rich diet and the impact of nutrients on the body; 2) understanding the difference between macro and micro nutrients; 3) identifying the nutrients your body needs and incorporating them into your diet; and 4) making more informed food purchasing decisions. The content overview includes 1) macronutrient breakdown; 2) micronutrient breakdown; and 3) other considerations.

For vital endurance engine 5—“Healthy Dining Habits,” the example overview is “Learn how to maintain healthy eating habits while eating out or on the go.” The skills to be gained are: 1) recognizing the impact of convenience food and coming up with a plan to avoid it; 2) making educated choices about which foods to buy and which to avoid when eating out; 3) practicing healthy eating habits all the time—whether you are at home, at a restaurant or on the road; and 4) asking questions and practicing food safety when dining out. The content overview includes 1) avoiding convenience food; and 2) “do's” and “don't” for eating out or on the go.

For vital endurance engine 6—“Label Reading and Smart Shopping,” the example overview is “Learn how to read a label and make healthy food purchasing decisions.” The skills to be gained are: 1) recognizing the importance of reading nutrition labels and being an informed consumer; 2) making healthy and informed food purchasing decisions at the supermarket; and 3) identifying ingredients that are bad for you and power foods that are beneficial for you.” The content overview includes 1) how to read a label; and 2) power foods and organics.

For vital endurance engine 7—“Federal Deposit Insurance Corporation,” the example overview is “Gain access to financial education resources provided by the Federal Deposit Insurance Corporation (FDIC).” Vital endurance engine 7 includes a link to the FDIC home page and to a computer-based instruction smart money program. The FDIC home page includes a comprehensive financial education curriculum designed to help low and moderate income individuals enhance their financial skills. The smart money program includes interactive financial education modules covering key topics such as home buying, debt, bankruptcy and credit scores.

For vital endurance engine 8—“Lutheran Social Services,” the example overview is “Gain access to financial counseling and debt management resources provided by Lutheran Social Services.” Vital endurance engine 8 includes a link to the Lutheran Social Service Home Page, providing financial counseling and debt management services. Educational programs, tools and resources are provided in the areas of budgeting, debt reduction, bankruptcy, credit reports, foreclosures and reverse mortgages.

For vital endurance engine 9—“U.S. Bank,” the example overview is “Gain access to financial education and credit wellness resources provided by U.S. Bank. Vital endurance engine 9 includes a link to a financial genius home page—U.S. Bank's financial education program. This page includes information about credit education, financial literacy for children and other areas of financial information.

For vital endurance engine 10—“Social Security Administration,”—the example overview is “Learn more about retirement and disability benefits provided by the Social Security Administration.” Vital endurance engine 10 includes links to Social Security benefits, including online services such as applying for Social Security, retirement benefits and disability benefits.

The financial information provided via vital endurance engines 7-10 and health care navigation engines 15-16 generally includes the following content: 1) purchasing a home, including information on whether to build, rent or buy, picking a neighborhood to live in, determining housing affordability and selecting a mortgage; 2) family budgeting, including balancing a checkbook, determining whether to have separate bank accounts, tracking spending, understanding spending limits and being a savvy consumer; 3) saving, including managing savings, emergency savings, retirement and college; 4) managing your credit score, including understanding ramifications from a bad credit score, understanding the cost of credit, understanding who monitors your credit score, understanding how to achieve and maintain a good credit score and how to read a credit report; 5) debt management, including understanding how to reduce your debt; 6) student loans, including what you need to know before taking out a student load, understanding the current student loan interest rate, including an interest rate increase as of Jul. 1, 2013, understanding forgiveness and forbearance of student loans and understanding income-based repayment plans; 7) estate planning basics, including wills and testaments, living wills, retirement projections, disability, long term care, irrevocable trusts and life insurance; 8) managing your taxes, including understanding tax credits; 9) credit card management; and 10) consumer protection, including stolen identity and how to recognize and avoid predatory financial scams.

Referring back to FIG. 14, the user interface screen 1400 also includes an area 1406 for interactive programs and tools that are available to corporate members. These programs and tools include onsite games, activities and groups that help promote physical activity and a healthy lifestyle. Programs and tools that are available for a business are listed in area 1406.

One example program is a company-wide physical activity program called the Big Game. In the Big Game, points are earned for exercise and there is competition for individual and team prizes. Another example program is a company-wide weight reduction program known as L.E.A.P (Live Eat Adapt Play). In the L.E.A.P program, groups of employees meet on a periodic basis, typically weekly, to learn about healthy lifestyles and to support employees with their weight loss goals.

As shown in FIG. 14, a link 1408 is provided for one program—The Big Game. When link 1408 is selected, an example user interface screen 1700 is displayed. The example user interface screen 1700 includes general information about the Big Game. A text box 1702 is also provided whereby the business user 114 can enter game points for the current week. A Submit button 1704 is provided for submitting the game points, and a View Summary link 1706 is provided for viewing a summary of Big Game points.

When the View Summary link 1706 is selected, an example Big Game summary user interface 1800 is displayed. The Big Game summary provides a summary of point totals for business user 114 and a team leaderboard. The example point summary 1802 shows points submitted for business user 114 on a weekly basis. The example team leaderboard 1804 lists point totals for teams competing in the Big Game.

In some embodiments the training modules disclosed herein also include information regarding stop points. As used herein, a stop point is a point in time in which a user of the health care may need to make a decision about how to proceed regarding a health care issue. Stop points identify standard processes within the health care system at which the user can request a modification to the processes to beneficially adjust the processes. For example, the user may be diagnosed with a disease. The user may need to decide whether to have surgery, whether to start chemotherapy or radiation treatment or whether to obtain a second opinion. At this example stop point, the training module may present options available to the user and to provide a “what if” analysis. An example “what if” analysis may include education on possible consequences of proceeding with different options available to the user—for example proceeding with surgery, chemotherapy or radiation treatment.

Stop points may also occur at one or more stages of using the health care system. For example, when choosing a doctor, a stop point may discuss “what if” possibilities of choosing a certain type of doctor, for example a family practice doctor, an internist or a specialist. As another example, a stop point may discuss the benefits of increasing a level of physical exercise of improving one's diet. Other stop points are possible.

As discussed earlier, when employees of a business learn to use the health care system and engage in healthy lifestyles, health care costs for the business may be reduced. To determine the extent to which employees are actually using the health care system, businesses may conduct surveys of their employees. For example, employees may be asked to fill out a survey indicating the extent to which the employee has improved his/her skills after completing each training module. The survey may be issued at multiple time periods, for example after completing a training module, after 6 months, after a year, etc. As another example, employees may be surveyed as to how the degree in which they eat healthy foods, what their weight is, their level of physical activity, etc. Other employee surveys are possible. The businesses may analyze the surveys to determine the extent to which the employees are implementing knowledge learned from the training modules and to provide help and encouragement to employees that may need additional training or support.

As another way in which businesses may obtain feedback on the effectiveness of the training modules, businesses may obtain an analysis of health care claims for their employees. The analysis of the health care claims may provide data such as total health care premiums, total annual claims paid, hospital costs for inpatients, hospital costs for outpatients, emergency room use, pharmacy costs, etc. The analysis of the health care claims may also provide a lifestyle indicator, providing costs to the business for various health issues of the employees, such as diabetes, low back pain, heart disease, high blood pressure and obesity. In some embodiments, the analysis of the health care claims may be automatically generated by a software program, for example a software program provided by a company specializing in this type of software.

As an additional aid to a business, the business may receive periodic reports summarizing various health care related items at the business. The reports may be used to track costs and user participation related to the health care related items. Some example health care related items that may be included in the report are: 1) a claims analysis for the employees of the business, similar to the claims analysis discussed earlier, herein; 2) a summary of employee performance on the training modules, for example for each training module the number of training seminars given, the number of times the training module was viewed online, the number of passing scores, the average score, the possible points and the average points; 3) employee survey results regarding the extent to which an employee perceives an improvement of skills for each of the training modules; 4) a summary of the number of employees participating in a disease or case management program offered by the business; 5) a summary of employee participation in custom health related programs offered by the business, such as The Big Game, L.E.A.P., etc.; 6) summaries of employee absenteeism and turn-over; 7) a summary of employee survey results on items such as overall health, nutrition, weight, physical activity, sleep, emotional health, happiness, and personal finances. Other report items are possible.

As a further aid to help an employee and to potentially reduce health care expenses for a business, disease and case management programs may be made available to employees. A disease program is a program to help an employee deal with a specific disease. Typically, a disease specialist, for example a nurse, may contact the patient and help the patient with medications, follow-up treatments, home-health aid and follow-up support. Similarly, a case management program is a program to help an employee deal with a specific medically related life situation, for example helping the employee to deal with recovery after surgery. Businesses have found that when employees make use of disease and case management programs, overall health care costs for the business can be decreased. The health care training and lifestyle programs discussed in this disclosure are based on concepts of organizational change and human capital optimization for a business organization. Key components of organizational change are organizational will, delivery system and strategic planning Key components of human capital optimization include training and educating, reducing stress and increasing happiness.

To implement organizational change in a business organization, a buy-in is needed by upper management and human resources. Once upper management and human resources are committed to organizational change, employees are more motivated and willing to accept and embrace change.

A change model may include four interconnected concepts to be addressed to help implement change—cue, routine, reward and craving. In general, employees need to be introduced to change programs and understand their importance. A delivery system needs to be setup that so that use of the health care training and lifestyle programs becomes part of an employees' workplace culture. Employees also need to be motivated to change and to be rewarded when change occurs.

A key component to implementing the health care training and lifestyle programs is the use of a life services consultant. The life services consultant is an individual that is knowledgeable about the health care system and the health care training and lifestyle programs and who has specific people and communication skills. The life services consultant is generally hired by a business organization to help implement the health care training and lifestyle programs in the business organization.

The life services consultant interacts with executive leadership, human resources, employees, insurance carriers and brokers. The life services consultant also helps implement a delivery system for the health care training and lifestyle programs.

When implementing a delivery system, the life services consultant designs and builds an infrastructure and strategic implementation plans for the business organization. The life services consultant typically makes multiple onsite visits, phone calls and emails per month, working closely with human resources and with executive leadership. A first layer of the infrastructure may include human resources and executive leadership.

In a second layer of the infrastructure, the life services consultant establishes a life services committee or uses an existing wellness committee in the business organization. The life services committee or wellness committee establishes a strategic direction for implementation of the health care training and lifestyle programs in the business organization and helps develop an annual plan and calendar. In a typical implementation, the strategic direction and implementation may occur within 60 days from the time that the life services consultant is hired.

In a next step, the life services consultant works with human resources to identify and recruit employees who are champions of healthy living. A champion of healthy living is an employee who is interested in healthy living and is are interested in taking a lead role in helping fellow employees learn and master the health care training and lifestyle programs. In a typical embodiment, one of the champions of healthy living facilitates the life services committee and the life services consultant manages the life services committee. Committee members are provided with information on their roles and expectations. The life services committee typically meets monthly.

In a third layer of the infrastructure, the life services consultant implements a weight management and healthy lifestyle change group with employees. This group meets weekly to support employees and also sponsors activities from the life services committee. One employee is typically recruited to facilitate the group; the life style consultant trains the group and helps manage the group.

In a final layer of the infrastructure, the lifestyle consultant implements the training modules for health care navigation and for vital endurance. At this point the entire business organization is involved. In addition to implementing the online version of these training modules, the lifestyle consultant may also implement onsite classes for the training modules. The lifestyle consultant may also implement a physical exercise program for the business organization, such as The Big Game.

Another key component in implementing the health care training and lifestyle programs is the use of incentives as a way to motivate and encourage employees. Incentives may be used in a number of different ways. For example, employees may be rewarded for successfully completing a training module. As another example, rewards may be given for losing a certain amount or percentage of weight. Additional rewards may be given for being on a team that finishes wins or finishes high in a competition for losing weight or in a physical activity competition such as the Big Game. Other uses of incentives are possible. The rewards may be in prizes, cash or in company recognitions, extra days off, etc.

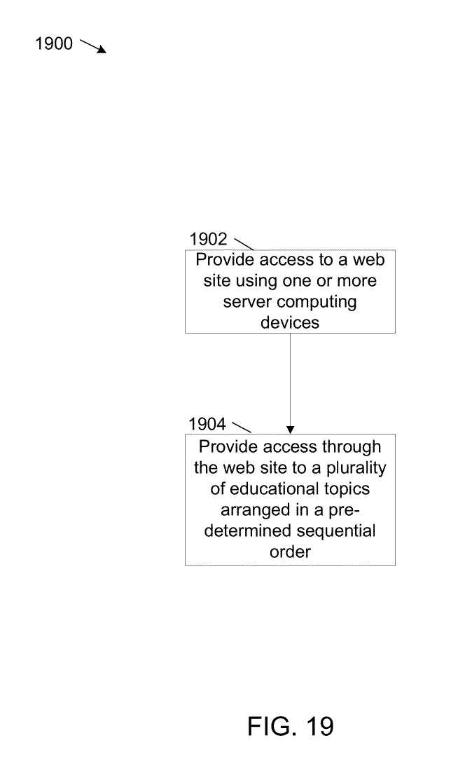

FIG. 19 shows an example flowchart for a method 1900 of educating a user on a health care system. At operation 1902, access to a web site is provided using one or more server computers, for example web server 108. The access to the web site is typically from a user computer device, for example from user computer device 102 or user computer device 104.

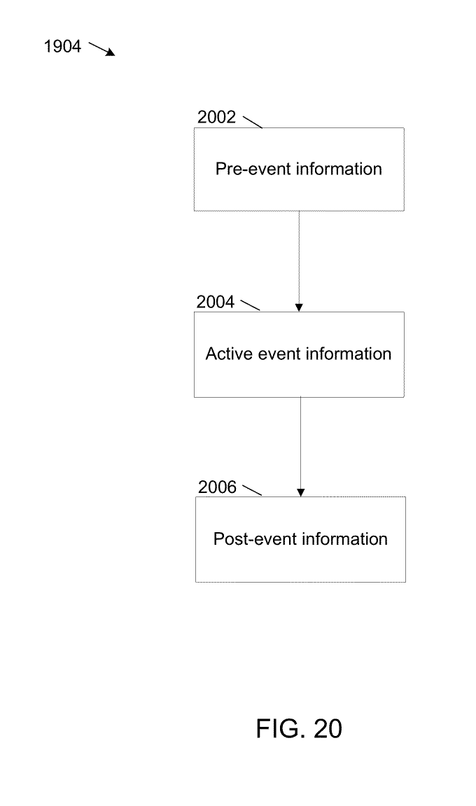

At operation 1904, access is provided through the web site to a plurality of educational topics. The educational topics relate to user interaction with and navigation through a health care system. The plurality of educational topics are arranged in a predetermined sequential order. An example of the predetermined sequential order is illustrated and described with reference to FIG. 20.

FIG. 20 shows an example of a predetermined sequential order of information provided by the method 1900, shown in FIG. 19. In this example, the sequential order includes pre-event information 2002, followed by active event information 2004, followed by post-event information 2006.

In some embodiments, the pre-event information 2002 includes information on one or more educational topics that educate the user on how to interact with the health care system before a health care event occurs. Examples of the pre-event information 2002 include information on how to fund health care when the healthcare event occurs and information on managing health care records generated during a health care event.

In some embodiments, the active event information 2004 includes information on one or more educational topics that educate the user on how to interact with the healthcare system during the occurrence of a healthcare event. Examples of the active event information 2004 include information to assist the user in verifying an illness, information to assist the user in selecting treatment options, information to assist the user in selecting a health care professional, information to assist the user while the user is a patient and information to assist the user when treatment ends. In some embodiments, the sequential order includes the active event information in order.

In some embodiments, the post-event information 2006 includes information on one or more educational topics that educate the user on how to interact with the health care system after one or more health care events has occurred. Examples of the post-event information 2006 include information on managing prescriptions and information on payment of a bill for the health care event.

In some embodiments the sequential order is defined by a web page that presents links to the educational topics arranged in the sequential order. Each of the educational topics is presented on a separate page of the web site. In some embodiments the predetermined sequential order provides a structure for the information in which the information presented later in the sequential order builds on the information presented earlier in the sequential order. In some embodiments the sequential order is substantially chronological with the order in which a user is likely to utilize the information. For example, in some embodiments the pre-event information provides information that a user can use before a health care event occurs, while active event information provides information that a user can use once the health care event has occurred, and the post-event information provides information that a user can use after the health care event has occurred. In some embodiments the web site requires that information be viewed in the sequential order in which it is arranged, such as by not permitting access to subsequent information until prior information has been accessed, while in other embodiments the user can select the order in which to view the information by selecting any one of the links to the information.

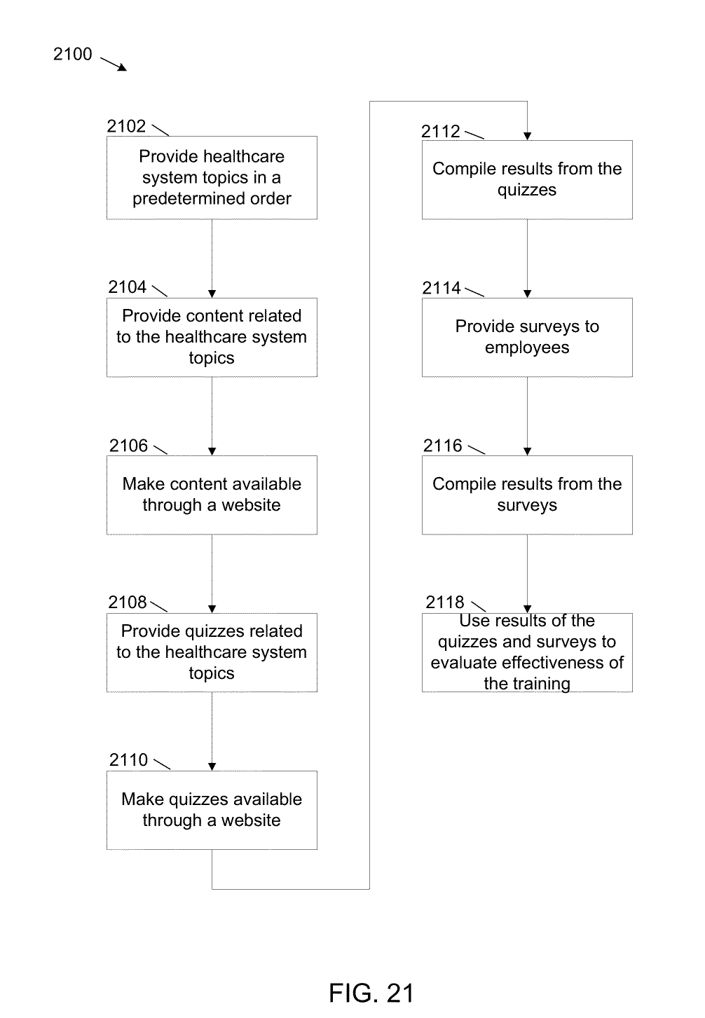

FIG. 21 shows an example flowchart for a method 2100 for monitoring health care system training effectiveness. At operation 2102, health care system topics are provided on a server computer in a predetermined order. For method 2100, the order is such that topics related to use of the health care system are presented first, followed by topics related to active engagement in the treatment of a disease, followed by topics related to post engagement of the disease.

At operation 2104, content related to the health care system topics is provided. The content is provided from a server computer through a website. The intent of the content is to train an individual, typically an employee of a business on the use of the health care system. For method 2100, the content is comprised of the content of the health care navigation modules previously described herein. In other methods, different content may be used.

At operation 2106, the content is made available through the website. Employees of the business may log on to the website and view the content. The topics and the content are provided in a sequential predetermined order. The topic order is such that each module builds on each other and permits the content to be learned in an organized, sequential manner. However, employees are permitted to view the topics and content in any order.

At operation 2108, quizzes related to the health care system topics are provided on the website. At operation 2110 the quizzes are made available through a website. Employees are encouraged to take the quizzes to provide feedback as to whether the content of the topics has been mastered. In some embodiments, businesses may provide incentives to employees who take and pass the quizzes. The incentives may include both monetary and non-monetary rewards. In addition, employees may receive a certificate of completion after completing the quizzes for a module.

At operation 2112, results from the quizzes are compiled. The results comprise statistics that the business can use to evaluate the effectiveness of the training modules and whether the employees are learning the content. The statistics may include data such as the number of employees taking quizzes on each module, the number of employees that have passed each module, the average score on each module, etc. Other statistics are possible.

At operation 2114, surveys are provided to the employees. One intent of the surveys is to determine to what extent the employees have made positive life style changes as a result of completing the training. For example, an employee may be asked questions related to the employees level of physical activity, the employees weight, nutrition, sleep habits, happiness, etc. The surveys may also be given at different times after completion of the training program, for example at 3 month, six month or yearly intervals, to determine whether progress is being made.

At operation 2116, the results of the surveys are compiled. In some embodiments, the results are compiled automatically, for example by a server computer. In other embodiments that results may be compiled manually.

At operation 2118, the results of the quizzes and surveys are used to evaluate the effectiveness of the training Business can use the results to determine the extent to which the training modules are being used, the extent to which employees are mastering the content of the training modules and the extent to which lifestyle changes are being made.

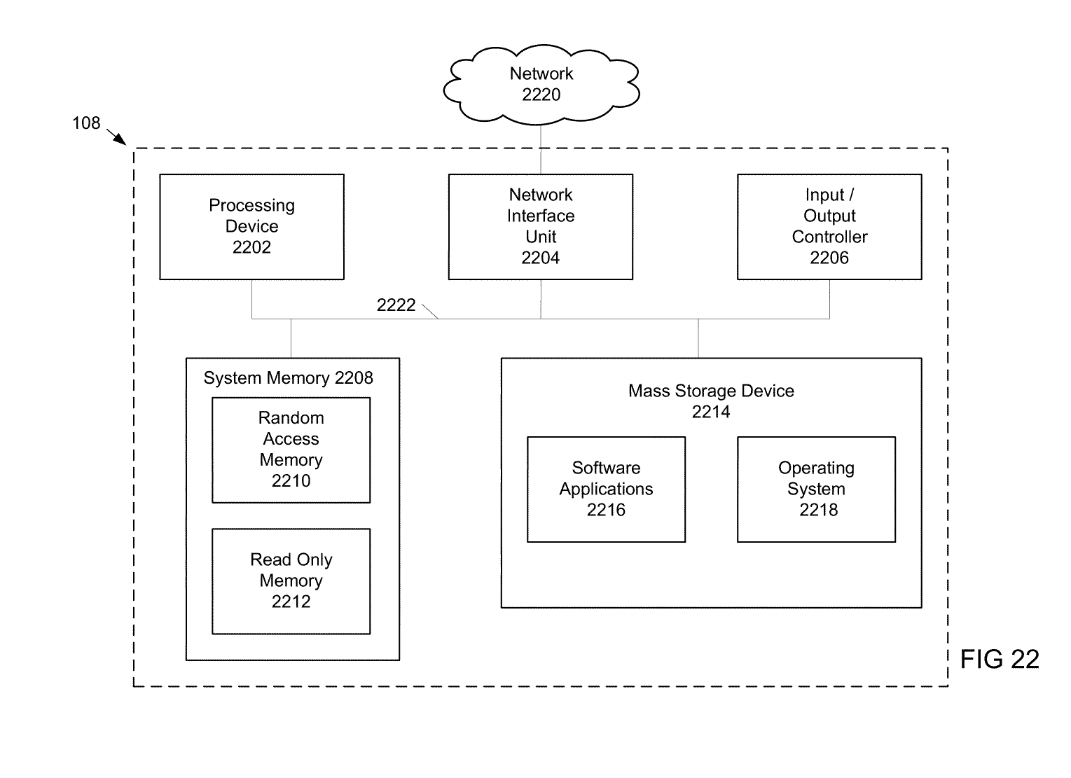

As illustrated in the example of FIG. 22, the web server 108 includes at least one processing device 2202 (such as a central processing unit) and a computer readable storage device. Although described in terms of the web server 108, the computing device depicted in FIG. 22 is also an example of any one or more of the other computing devices described herein (including, for example, the user computing devices 102 and 104, computing devices utilized within the health care system 120, and computing devices utilized by the health care consultants 118, all shown in FIG. 1), and therefore the structure of such devices will not be separately repeated herein.

In this example, the web server 108 includes a processing device 2202, a system memory 2208, and a system bus 2220 that couples the system memory 2208 to the processing device 2202. The system memory 2208 includes a random access memory (“RAM”) 2210 and a read-only memory (“ROM”) 2212. A basic input/output system contains the basic routines that help to transfer information between elements within the web server 108, such as during startup, is stored in the ROM 2212. The web server 108 further includes a mass storage device 2214. The mass storage device 2214 is able to store software instructions and data.

The mass storage device 2214 is connected to the processing device 2202 through a mass storage controller (not shown) connected to the bus 2220. The mass storage device 2214 and its associated computer-readable data storage media provide non-volatile, non-transitory storage for the web server 108. Although the description of computer-readable data storage media contained herein refers to a mass storage device, such as a hard disk or solid state disk, it should be appreciated by those skilled in the art that computer-readable data storage media can be and are limited to any available non-transitory, physical device or article of manufacture from which the processing device 2102 can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the web server 108. A computer readable storage device is a non-transitory physical device including at least one computer-readable data storage medium.

According to various embodiments of the invention, the web server 108 may operate in a networked environment using logical connections to remote network devices through the network 2218, such as a local network, the Internet, or another type of network. The web server 108 may connect to the network 2218 through a network interface unit 2204 connected to the bus 2220. It should be appreciated that the network interface unit 2204 may also be utilized to connect to other types of networks and remote computing systems. The web server 108 also includes an input/output controller 2206 for receiving and processing input from a number of other devices, including a keyboard, a mouse, a touch user interface display screen, or another type of input device. Similarly, the input/output controller 2206 may provide output to a touch user interface display screen, a printer, or other type of output device.

As mentioned briefly above, the mass storage device 2214 and the RAM 2210 of the web server 108 can store software instructions and data. The software instructions include an operating system 2216 suitable for controlling the operation of the web server 108. The mass storage device 2214 and/or the RAM 2210 also store software instructions, that when executed by the processing device 2202, cause the web server 108 to provide the functionality of the web server 108 discussed in this document. For example, the mass storage device 2214 and/or the RAM 2210 can store software instructions that, when executed by the processing device 2202, cause the web server 108 to communicate web page data to user computing device 102 or user computing device 104.

Other example physical components of the web server 108 are possible. In general, the web server 108 supports a computing platform that provides capabilities for a standardized interface (for example USB), a standardized wireless communication interface (for example Bluetooth or NFC) and a user interface.

Although the present disclosure refers to example implementations involving a web server that generates a web site, such as can be accessed through a web browser software application operating on a computing device, other embodiments are implemented in other ways. For example, some embodiments include a software application operating on a computing device which presents the information described herein. As another example, some embodiments are implemented as a software app operating on a computing device, such as a smartphone or a tablet computer.

Some embodiments are implemented involving a cloud-based data storage system or a cloud-based server computing device.

References to web page elements are also provided by way of example and not of limitation. For example, the links and buttons described herein can be implemented as another form of selectable control, including touch sensitive elements or software controls. Inputs can be provided by a user utilizing any suitable input technology, such as a pointer device, a touch sensitive display, voice recognition technology, and the like.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method of educating a user on a health care system, the method comprising:
providing access to a web site using one or more server computing devices;
providing access to a plurality of educational topics through the web site, the plurality of educational topics relating to user interaction with and navigation through a health care system, the plurality of educational topics being arranged in a pre-determined sequential order including, in order:
pre-event information including information on one or more educational topics that educate the user on how to interact with the health care system before a health care event occurs;
active event information including information on one or more educational topics that educate the user on how to interact with the health care system during the occurrence of a health care event; and
post-event information including information on one or more educational topics that educate the user on how to interact with the health care system after one or more health care events has occurred.

2. The method of claim 1, wherein the pre-event information includes financial information on how to fund health care when the health care event occurs, and information on managing health care records generated during a health care event.

3. The method of claim 1, wherein the active event information includes:
information to assist the user in verifying an illness;
information to assist the user in selecting treatment options;
information to assist the user in selecting a health care professional;
information to assist the user while the user is a patient; and
information to assist the user when treatment ends.

4. The method of claim 3, wherein the sequential order includes the active event information in order.

5. The method of claim 1, wherein the post-event information includes information on managing prescriptions and information on payment of a bill for the health care event.

6. The method of claim 1, wherein the health care system includes policies and procedures defined by health insurance companies and policies and procedures defined by health care administrators.

7. The method of claim 1, wherein the educational topics identify stop points within standard processes within the health care system at which the user can request a modification to the processes to beneficially adjust the processes.

8. The method of claim 1, wherein the plurality of educational topics further include long-term care information including information on one or more educational topics that educate the user on how to interact with the health care system during a chronic or other long-term health care event.

9. The method of claim 1, wherein the sequential order is defined by a web page that presents links to the educational topics arranged in the sequential order.

10. The method of claim 1, wherein each of the educational topics is presented on a separate web page of the web site.

11. The method of claim 10, wherein the educational topics are presented through a variety of media, including at least a written form and a video form.

12. The method of claim 1, further comprising:
providing quizzes related to each of the plurality of educational topics; and
providing access to the quizzes through the website.

13. The method of claim 12, further comprising providing incentives to the user based on performance of the quizzes.

14. The method of claim 1, further comprising receiving survey information from the user regarding the effectiveness of the educational topics and using the survey information to evaluate the effectiveness of the educational topics.

15. A method for monitoring health care system training effectiveness for employees of a business, the method comprising:
providing health care system topics in a predetermined order;
providing content relating to the health care system topics, the content being provided from a server computer through a website;
making the content available through the website to train the employees on the health care system topics;
providing quizzes related to the health care system topics;
making the quizzes available through the website to the employees;
compiling results from the quizzes;
providing surveys to the employees to receive employee feedback on the content;
compiling results from the surveys; and
using the results of the quizzes and surveys to evaluate the effectiveness of the training.

16. The method of claim 15, wherein the health care system topics are arranged in a pre-determined sequential order including, in order:
pre-event information, including information on one or more health care system topics that educate employees on how to interact with the health care system before a health care event occurs;
active event information including information on one or more educational topics that educate the employees on how to interact with the health care system during the occurrence of a health care event; and
post-event information including information on one or more educational topics that educate the employees on how to interact with the health care system after one or more health care events has occurred.

17. The method of claim 16, wherein the sequential order is defined by a web page that presents links to the educational topics arranged in the sequential order.

18. The method of claim 15, wherein the health care system topics identify stop points within standard processes within the health care system at which the employees can request a modification to the processes to beneficially adjust the processes.

19. The method of claim 15, further comprising analyzing health care claims from the employees to determine whether skills learned from the content have been applied.

20. A server computer comprising:
a processing unit; and
memory, the memory storing instructions that, when executed by the processing unit, cause the server computer to:
host a web site that provides a plurality of educational topics;
provide access to the plurality of educational topics through the web site, the plurality of educational topics relating to user interaction with and navigation through a health care system, the plurality of educational topics being arranged in a pre-determined sequential order including, in order:
pre-event information including information on one or more educational topics that educate the user on how to interact with the health care system before a health care event occurs, the pre-event information including financial information on how to fund health care when the health care event occurs, and information on managing health care records generated during a health care event;
active event information including information on one or more educational topics that educate the user on how to interact with the health care system during the occurrence of a health care event, the active event information including:
information to assist the user in verifying an illness;
information to assist the user in selecting treatment options;
information to assist the user in selecting a health care professional;
information to assist the user while the user is a patient;
and information to assist the user when treatment ends; and
post-event information including information on one or more educational topics that educate the user on how to interact with the health care system after one or more health care events has occurred, the post-event information including information on managing prescriptions and information on payment of a bill for the health care event;
provide quizzes related to each of the plurality of educational topics;
provide access to the quizzes through the website;
provide incentives to the user based on the performance on the quizzes;
receive survey information from the user regarding the effectiveness of the educational topics; and
provide reports summarizing the survey information and the user performance on the quizzes.
